(19) United States
(12) Patent Application Publication
(10) Pub. No.: US 2022/0374069 A1
(43) Pub. Date: Nov. 24, 2022

(54) WEARABLE SYSTEMS AND METHODS FOR LOCATING AN OBJECT

(71) Applicant: ORCAM TECHNOLOGIES LTD., Jerusalem (IL)

(72) Inventors: YONATAN WEXLER, Jerusalem (IL); AMNON SHASHUA, Jerusalem (IL)

(21) Appl. No.: 17/774,342

(22) PCT Filed: Nov. 16, 2020
(86) PCT No.: PCT/IB2020/000951

§ 371 Date: May 4, 2022

Related U.S. Application Data
(60) Provisional application No. 62/937,275, filed on Nov. 19, 2019.

(51) Int. Cl. G06F 3/01; G06F 3/16; G06V 20/64; G06V 20/20; G06V 40/10; G10L 15/22

(52) U.S. Cl. CPC G06F 3/011; G06F 3/016; G06F 3/167; G06V 20/64; G06V 20/20; G06V 40/10; G10L 15/22; G10L 2015/223; G10L 2015/225

(57) ABSTRACT

Systems and methods are disclosed for locating an object for a user. A system may comprise an image capture device, an audio capture device, and a processor. The processor may be configured to receive images captured by the image capture device and audio signals received by the audio capture device. The processor may analyze the audio signals to identify a descriptor word describing the object and retrieve a visual characteristic of the object based on the descriptor word. The processor may then determine a location of the object in the images based on the visual characteristic, determine a location of a hand of the user in the images, and determine a direction between the hand and the object. The processor may then determine feedback indicative of the direction and provide the feedback to the user.

### CROSS REFERENCE TO RELATED APPLICATION

This application claims the benefit of priority of U.S. Provisional Patent Application No. 62/937,275, filed on Nov. 19, 2019, which is incorporated herein by reference in its entirety.

### BACKGROUND

### Technical Field

This disclosure generally relates to devices and methods for capturing and processing images and audio from an environment of a user, and using information derived from captured images and audio.

### Background Information

Today, technological advancements make it possible for wearable devices to automatically capture images and audio, and store information that is associated with the captured images and audio. Certain devices have been used to digitally record aspects and personal experiences of one's life in an exercise typically called “lifelogging.” Some individuals log their life so they can retrieve moments from past activities, for example, social events, trips, etc. Lifelogging may also have significant benefits in other fields (e.g., business, fitness and healthcare, and social research). Lifelogging devices, while useful for tracking daily activities, may be improved with capability to enhance one's interaction in his environment with feedback and other advanced functionality based on the analysis of captured image and audio data.

Even though users can capture images and audio with their smartphones and some smartphone applications can process the captured information, smartphones may not be the best platform for serving as lifelogging apparatuses in view of their size and design. Lifelogging apparatuses should be small and light, so they can be easily worn. Moreover, with improvements in image capture devices, including wearable apparatuses, additional functionality may be provided to assist users in navigating in and around an environment, identifying persons and objects they encounter, and providing feedback to the users about their surroundings and activities. Therefore, there is a need for apparatuses and methods for automatically capturing and processing images and audio to provide useful information to users of the apparatuses, and for systems and methods to process and leverage information gathered by the apparatuses.

### SUMMARY

Embodiments consistent with the present disclosure provide devices and methods for automatically capturing and processing images and audio from an environment of a user, and systems and methods for processing information related to images and audio captured from the environment of the user.

In an exemplary embodiment, a wearable apparatus may comprise at least one image capture device configured to capture a plurality of images from an environment of the user of the wearable apparatus; at least one audio capture device configured to receive sounds from the environment of the user; and at least one processor. The at least one processor may be configured to receive the plurality of images captured by the image capture device; receive audio signals representative of the sounds received by the audio capture device; analyze the audio signals to identify a descriptor word describing the object; retrieve, from a database, a visual characteristic of the object based on the descriptor word; determine a location of the object based on a representation of the object in at least one of the plurality of images, the representation of the object being identified based on the visual characteristic; determine a location of a hand of the user based on a representation of the hand in at least one of the plurality of images; determine at least a direction between the hand and the object; determine feedback indicative of the direction; and provide the feedback to the user.

In another exemplary embodiment, a method for locating an object for a user is disclosed.

The method may comprise receiving a plurality of images captured by an image capture device from an environment of the user; receiving audio signals representative of sounds received by an audio capture device from the environment of the user; analyzing the audio signals to identify a descriptor word describing the object; retrieving, from a database, a visual characteristic of the object based on the descriptor word; determining a location of the object based on a representation of the object in at least one of the plurality of images, the representation of the object being identified based on the visual characteristic; determining a location of a hand of the user based on a representation of the hand in at least one of the plurality of images; determining at least a direction between the hand and the object; determining feedback indicative of the direction; and providing the feedback to the user.

In another exemplary embodiment, non-transitory computer readable storage media may include instructions that, when executed by at least one processor, cause the at least one processor to perform operations for locating an object for a user. The operations may comprise receiving a plurality of images captured by an image capture device from an environment of the user; receiving audio signals representative of sounds received by an audio capture device from the environment of the user; analyzing the audio signals to identify a descriptor word describing the object; retrieving, from a database, a visual characteristic of the object based on the descriptor word; determining a location of the object based on a representation of the object in at least one of the plurality of images, the representation of the object being identified based on the visual characteristic; determining a location of a hand of the user based on a representation of the hand in at least one of the plurality of images; determining at least a direction between the hand and the object; determining feedback indicative of the direction; and providing the feedback to the user.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a schematic illustration of an example of a user wearing a wearable apparatus according to a disclosed embodiment.

FIG. 1B is a schematic illustration of an example of the user wearing a wearable apparatus according to a disclosed embodiment.

FIG. 1C is a schematic illustration of an example of the user wearing a wearable apparatus according to a disclosed embodiment.

FIG. 1D is a schematic illustration of an example of the user wearing a wearable apparatus according to a disclosed embodiment.

FIG. 2 is a schematic illustration of an example system consistent with the disclosed embodiments.

FIG. 3A is a schematic illustration of an example of the wearable apparatus shown in FIG. 1A.

FIG. 3B is an exploded view of the example of the wearable apparatus shown in FIG. 3A.

FIG. 4A-4K are schematic illustrations of an example of the wearable apparatus shown in FIG. 1B from various viewpoints.

FIG. 5A is a block diagram illustrating an example of the components of a wearable apparatus according to a first embodiment.

FIG. 5B is a block diagram illustrating an example of the components of a wearable apparatus according to a second embodiment.

FIG. 5C is a block diagram illustrating an example of the components of a wearable apparatus according to a third embodiment.

FIG. 6 illustrates an exemplary embodiment of a memory containing software modules consistent with the present disclosure.

FIG. 7 is a schematic illustration of an embodiment of a wearable apparatus including an orientable image capture unit.

FIG. 8 is a schematic illustration of an embodiment of a wearable apparatus securable to an article of clothing consistent with the present disclosure.

FIG. 9 is a schematic illustration of a user wearing a wearable apparatus consistent with an embodiment of the present disclosure.

FIG. 10 is a schematic illustration of an embodiment of a wearable apparatus securable to an article of clothing consistent with the present disclosure.

FIG. 11 is a schematic illustration of an embodiment of a wearable apparatus securable to an article of clothing consistent with the present disclosure.

FIG. 12 is a schematic illustration of an embodiment of a wearable apparatus securable to an article of clothing consistent with the present disclosure.

FIG. 13 is a schematic illustration of an embodiment of a wearable apparatus securable to an article of clothing consistent with the present disclosure.

FIG. 14 is a schematic illustration of an embodiment of a wearable apparatus securable to an article of clothing consistent with the present disclosure.

FIG. 15 is a schematic illustration of an embodiment of a wearable apparatus power unit including a power source.

FIG. 16 is a schematic illustration of an exemplary embodiment of a wearable apparatus including protective circuitry.

FIG. 17 is a block diagram illustrating components of wearable apparatus, consistent with the disclosed embodiments.

FIG. 18 is a block diagram illustrating an example embodiment of a memory containing various components, consistent with the disclosed embodiments.

FIG. 19 is an illustration of an example image that may be used for locating an object, consistent with the disclosed embodiments.

FIGS. 20A and 20B illustrate various forms of feedback that may be provided to a user, consistent with the disclosed embodiments.

FIG. 21 is a flowchart showing an example process for locating an object for a user, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

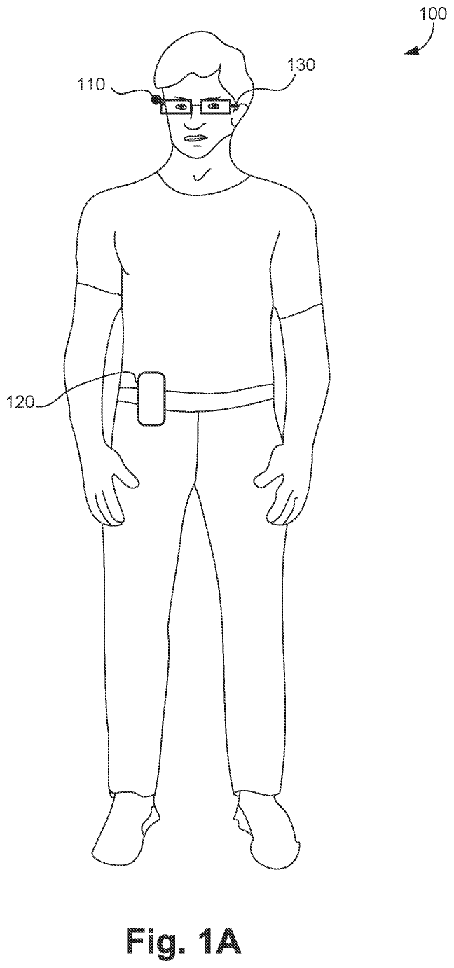

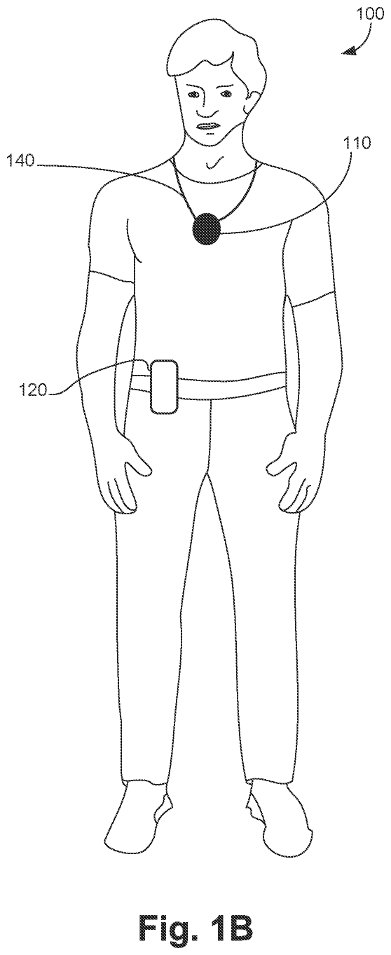

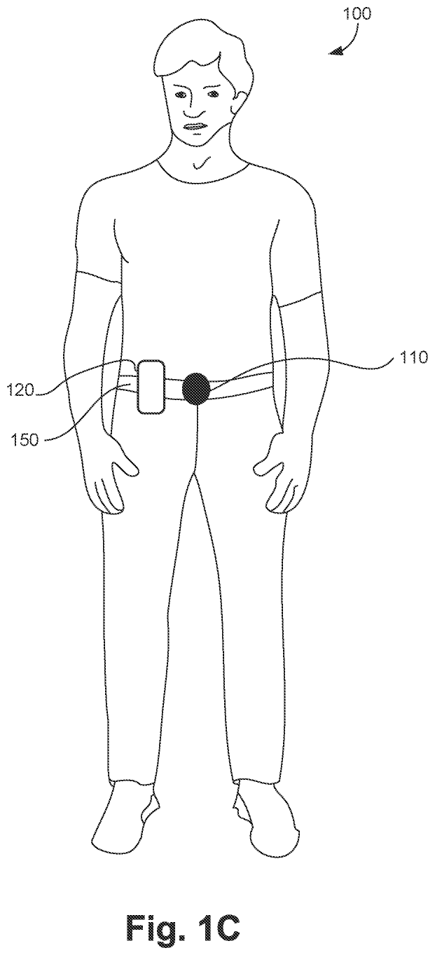

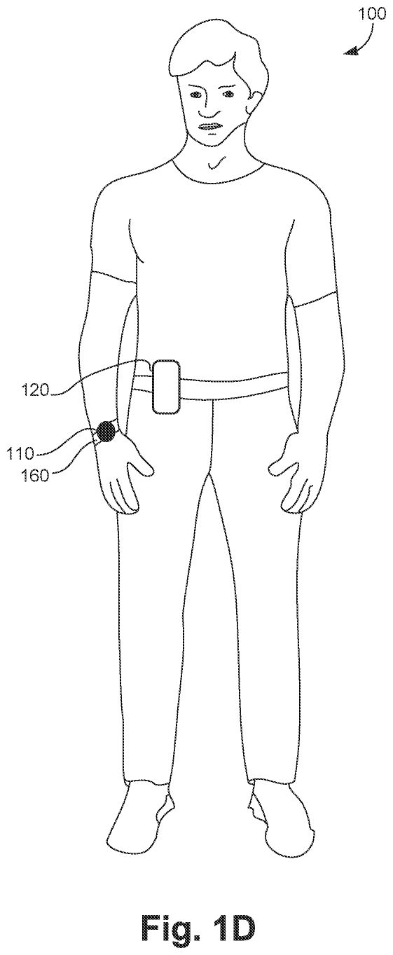

FIG. 1A illustrates a user 100 wearing an apparatus 110 that is physically connected (or integral) to glasses 130, consistent with the disclosed embodiments. Glasses 130 may be prescription glasses, magnifying glasses, non-prescription glasses, safety glasses, sunglasses, etc. Additionally, in some embodiments, glasses 130 may include parts of a frame and earpieces, nosepieces, etc., and one or no lenses. Thus, in some embodiments, glasses 130 may function primarily to support apparatus 110, and/or an augmented reality display device or other optical display device. In some embodiments, apparatus 110 may include an image sensor (not shown in FIG. 1A) for capturing real-time image data of the field-of-view of user 100. The term “image data” includes any form of data retrieved from optical signals in the near-infrared, infrared, visible, and ultraviolet spectrums. The image data may include video clips and/or photographs.

In some embodiments, apparatus 110 may communicate wirelessly or via a wire with a computing device 120. In some embodiments, computing device 120 may include, for example, a smartphone, or a tablet, or a dedicated processing unit, which may be portable (e.g., can be carried in a pocket of user 100). Although shown in FIG. 1A as an external device, in some embodiments, computing device 120 may be provided as part of wearable apparatus 110 or glasses 130, whether integral thereto or mounted thereon. In some embodiments, computing device 120 may be included in an augmented reality display device or optical head mounted display provided integrally or mounted to glasses 130. In other embodiments, computing device 120 may be provided as part of another wearable or portable apparatus of user 100 including a wrist-strap, a multifunctional watch, a button, a clip-on, etc. And in other embodiments, computing device 120 may be provided as part of another system, such as an on-board automobile computing or navigation system. A person skilled in the art can appreciate that different types of computing devices and arrangements of devices may implement the functionality of the disclosed embodiments. Accordingly, in other implementations, computing device 120 may include a Personal Computer (PC), laptop, an Internet server, etc.

FIG. 1B illustrates user 100 wearing apparatus 110 that is physically connected to a necklace 140, consistent with a disclosed embodiment. Such a configuration of apparatus 110 may be suitable for users that do not wear glasses some or all of the time. In this embodiment, user 100 can easily wear apparatus 110, and take it off.

FIG. 1C illustrates user 100 wearing apparatus 110 that is physically connected to a belt 150, consistent with a disclosed embodiment. Such a configuration of apparatus 110 may be designed as a belt buckle. Alternatively, apparatus 110 may include a clip for attaching to various clothing articles, such as belt 150, or a vest, a pocket, a collar, a cap or hat or other portion of a clothing article.

FIG. 1D illustrates user 100 wearing apparatus 110 that is physically connected to a wrist strap 160, consistent with a disclosed embodiment. Although the aiming direction of apparatus 110, according to this embodiment, may not match the field-of-view of user 100, apparatus 110 may include the ability to identify a hand-related trigger based on the tracked eye movement of a user 100 indicating that user 100 is looking in the direction of the wrist strap 160. Wrist strap 160 may also include an accelerometer, a gyroscope, or other sensor for determining movement or orientation of a user's 100 hand for identifying a hand-related trigger.

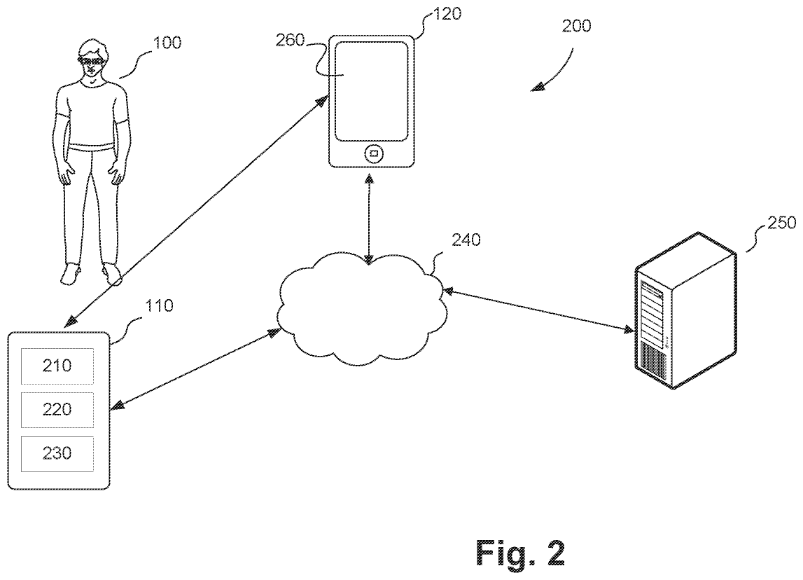

FIG. 2 is a schematic illustration of an exemplary system 200 including a wearable apparatus 110, worn by user 100, and an optional computing device 120 and/or a server 250 capable of communicating with apparatus 110 via a network 240, consistent with disclosed embodiments. In some embodiments, apparatus 110 may capture and analyze image data, identify a hand-related trigger present in the image data, and perform an action and/or provide feedback to a user 100, based at least in part on the identification of the hand-related trigger. In some embodiments, optional computing device 120 and/or server 250 may provide additional functionality to enhance interactions of user 100 with his or her environment, as described in greater detail below.

According to the disclosed embodiments, apparatus 110 may include an image sensor system 220 for capturing real-time image data of the field-of-view of user 100. In some embodiments, apparatus 110 may also include a processing unit 210 for controlling and performing the disclosed functionality of apparatus 110, such as to control the capture of image data, analyze the image data, and perform an action and/or output a feedback based on a hand-related trigger identified in the image data. According to the disclosed embodiments, a hand-related trigger may include a gesture performed by user 100 involving a portion of a hand of user 100. Further, consistent with some embodiments, a hand-related trigger may include a wrist-related trigger. Additionally, in some embodiments, apparatus 110 may include a feedback outputting unit 230 for producing an output of information to user 100.

As discussed above, apparatus 110 may include an image sensor 220 for capturing image data. The term “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 220 may be part of a camera included in apparatus 110.

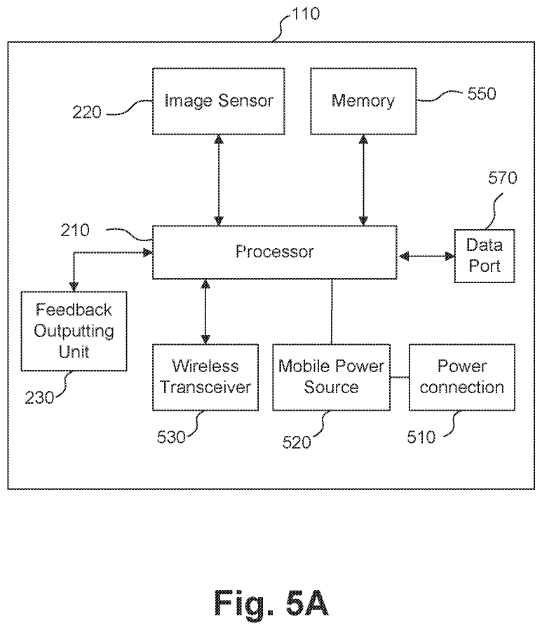

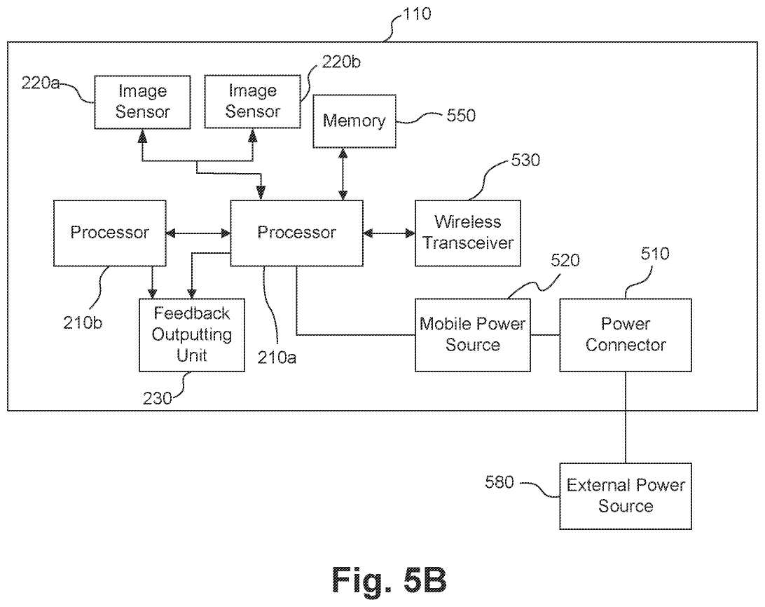

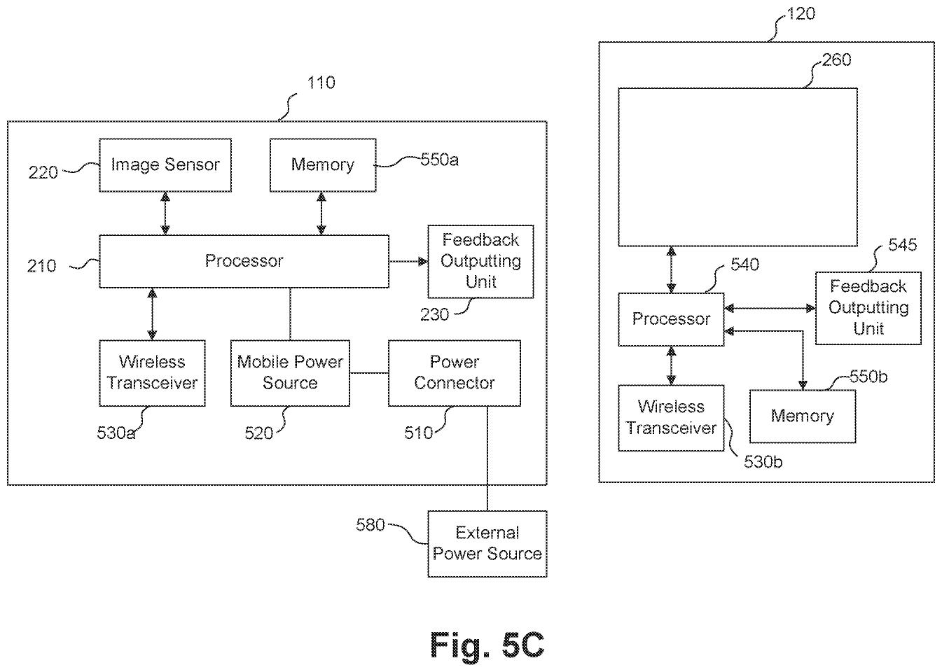

Apparatus 110 may also include a processor 210 for controlling image sensor 220 to capture image data and for analyzing the image data according to the disclosed embodiments. As discussed in further detail below with respect to FIG. 5A, processor 210 may include a “processing device” for performing logic operations on one or more inputs of image data and other data according to stored or accessible software instructions providing desired functionality. In some embodiments, processor 210 may also control feedback outputting unit 230 to provide feedback to user 100 including information based on the analyzed image data and the stored software instructions. As the term is used herein, a “processing device” may access memory where executable instructions are stored or, in some embodiments, a “processing device” itself may include executable instructions (e.g., stored in memory included in the processing device).

In some embodiments, the information or feedback information provided to user 100 may include time information. The time information may include any information related to a current time of day and, as described further below, may be presented in any sensory perceptive manner. In some embodiments, time information may include a current time of day in a preconfigured format (e.g., 2:30 pm or 14:30). Time information may include the time in the user's current time zone (e.g., based on a determined location of user 100), as well as an indication of the time zone and/or a time of day in another desired location. In some embodiments, time information may include a number of hours or minutes relative to one or more predetermined times of day. For example, in some embodiments, time information may include an indication that three hours and fifteen minutes remain until a particular hour (e.g., until 6:00 pm), or some other predetermined time. Time information may also include a duration of time passed since the beginning of a particular activity, such as the start of a meeting or the start of a jog, or any other activity. In some embodiments, the activity may be determined based on analyzed image data. In other embodiments, time information may also include additional information related to a current time and one or more other routine, periodic, or scheduled events. For example, time information may include an indication of the number of minutes remaining until the next scheduled event, as may be determined from a calendar function or other information retrieved from computing device 120 or server 250, as discussed in further detail below.

Feedback outputting unit 230 may include one or more feedback systems for providing the output of information to user 100. In the disclosed embodiments, the audible or visual feedback may be provided via any type of connected audible or visual system or both. Feedback of information according to the disclosed embodiments may include audible feedback to user 100 (e.g., using a Bluetooth™ or other wired or wirelessly connected speaker, or a bone conduction headphone). Feedback outputting unit 230 of some embodiments may additionally or alternatively produce a visible output of information to user 100, for example, as part of an augmented reality display projected onto a lens of glasses 130 or provided via a separate heads up display in communication with apparatus 110, such as a display 260 provided as part of computing device 120, which may include an onboard automobile heads up display, an augmented reality device, a virtual reality device, a smartphone, PC, table, etc.

The term “computing device” refers to a device including a processing unit and having computing capabilities. Some examples of computing device 120 include a PC, laptop, tablet, or other computing systems such as an on-board computing system of an automobile, for example, each configured to communicate directly with apparatus 110 or server 250 over network 240. Another example of computing device 120 includes a smartphone having a display 260. In some embodiments, computing device 120 may be a computing system configured particularly for apparatus 110, and may be provided integral to apparatus 110 or tethered thereto. Apparatus 110 can also connect to computing device 120 over network 240 via any known wireless standard (e.g., Wi-Fi, Bluetooth®, etc.), as well as near-filed capacitive coupling, and other short range wireless techniques, or via a wired connection. In an embodiment in which computing device 120 is a smartphone, computing device 120 may have a dedicated application installed therein. For example, user 100 may view on display 260 data (e.g., images, video clips, extracted information, feedback information, etc.) that originate from or are triggered by apparatus 110. In addition, user 100 may select part of the data for storage in server 250.

Network 240 may be a shared, public, or private network, may encompass a wide area or local area, and may be implemented through any suitable combination of wired and/or wireless communication networks. Network 240 may further comprise an intranet or the Internet. In some embodiments, network 240 may include short range or near-field wireless communication systems for enabling communication between apparatus 110 and computing device 120 provided in close proximity to each other, such as on or near a user's person, for example. Apparatus 110 may establish a connection to network 240 autonomously, for example, using a wireless module (e.g., Wi-Fi, cellular). In some embodiments, apparatus 110 may use the wireless module when being connected to an external power source, to prolong battery life. Further, communication between apparatus 110 and server 250 may be accomplished through any suitable communication channels, such as, for example, a telephone network, an extranet, an intranet, the Internet, satellite communications, off-line communications, wireless communications, transponder communications, a local area network (LAN), a wide area network (WAN), and a virtual private network (VPN).

As shown in FIG. 2, apparatus 110 may transfer or receive data to/from server 250 via network 240. In the disclosed embodiments, the data being received from server 250 and/or computing device 120 may include numerous different types of information based on the analyzed image data, including information related to a commercial product, or a person's identity, an identified landmark, and any other information capable of being stored in or accessed by server 250. In some embodiments, data may be received and transferred via computing device 120. Server 250 and/or computing device 120 may retrieve information from different data sources (e.g., a user specific database or a user's social network account or other account, the Internet, and other managed or accessible databases) and provide information to apparatus 110 related to the analyzed image data and a recognized trigger according to the disclosed embodiments. In some embodiments, calendar-related information retrieved from the different data sources may be analyzed to provide certain time information or a time-based context for providing certain information based on the analyzed image data.

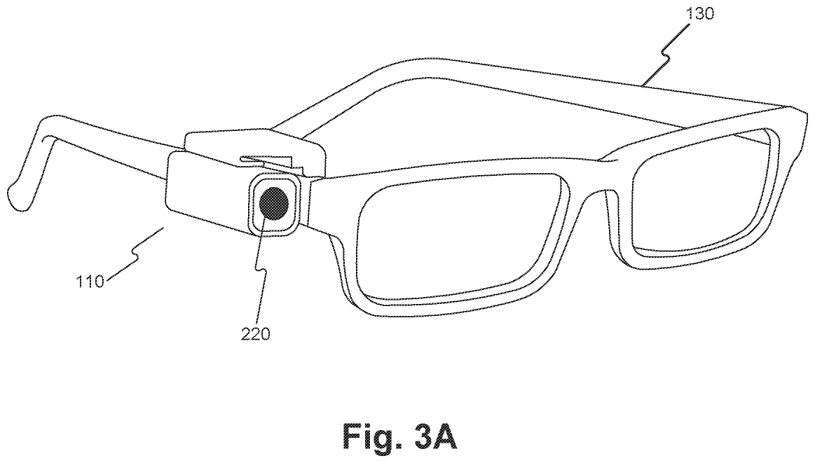

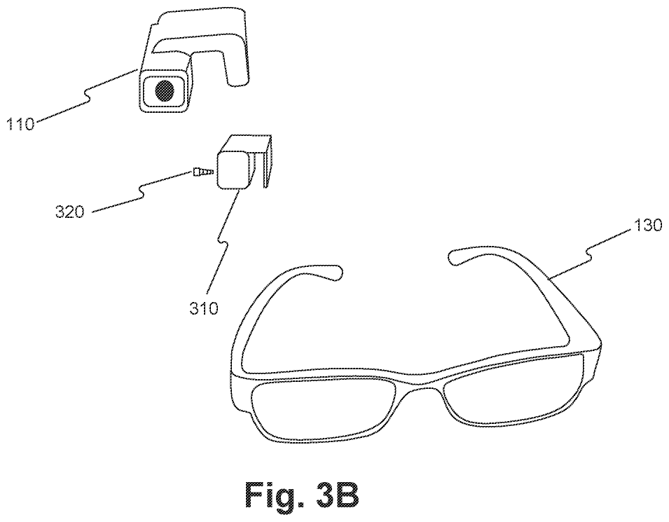

An example of wearable apparatus 110 incorporated with glasses 130 according to some embodiments (as discussed in connection with FIG. 1A) is shown in greater detail in FIG. 3A. In some embodiments, apparatus 110 may be associated with a structure (not shown in FIG. 3A) that enables easy detaching and reattaching of apparatus 110 to glasses 130. In some embodiments, when apparatus 110 attaches to glasses 130, image sensor 220 acquires a set aiming direction without the need for directional calibration. The set aiming direction of image sensor 220 may substantially coincide with the field-of-view of user 100. For example, a camera associated with image sensor 220 may be installed within apparatus 110 in a predetermined angle in a position facing slightly downwards (e.g., 5-15 degrees from the horizon). Accordingly, the set aiming direction of image sensor 220 may substantially match the field-of-view of user 100.

FIG. 3B is an exploded view of the components of the embodiment discussed regarding FIG. 3A. Attaching apparatus 110 to glasses 130 may take place in the following way. Initially, a support 310 may be mounted on glasses 130 using a screw 320, in the side of support 310. Then, apparatus 110 may be clipped on support 310 such that it is aligned with the field-of-view of user 100. The term “support” includes any device or structure that enables detaching and reattaching of a device including a camera to a pair of glasses or to another object (e.g., a helmet). Support 310 may be made from plastic (e.g., polycarbonate), metal (e.g., aluminum), or a combination of plastic and metal (e.g., carbon fiber graphite). Support 310 may be mounted on any kind of glasses (e.g., eyeglasses, sunglasses, 3D glasses, safety glasses, etc.) using screws, bolts, snaps, or any fastening means used in the art.

In some embodiments, support 310 may include a quick release mechanism for disengaging and reengaging apparatus 110. For example, support 310 and apparatus 110 may include magnetic elements. As an alternative example, support 310 may include a male latch member and apparatus 110 may include a female receptacle. In other embodiments, support 310 can be an integral part of a pair of glasses, or sold separately and installed by an optometrist. For example, support 310 may be configured for mounting on the arms of glasses 130 near the frame front, but before the hinge. Alternatively, support 310 may be configured for mounting on the bridge of glasses 130.

In some embodiments, apparatus 110 may be provided as part of a glasses frame 130, with or without lenses. Additionally, in some embodiments, apparatus 110 may be configured to provide an augmented reality display projected onto a lens of glasses 130 (if provided), or alternatively, may include a display for projecting time information, for example, according to the disclosed embodiments. Apparatus 110 may include the additional display or alternatively, may be in communication with a separately provided display system that may or may not be attached to glasses 130.

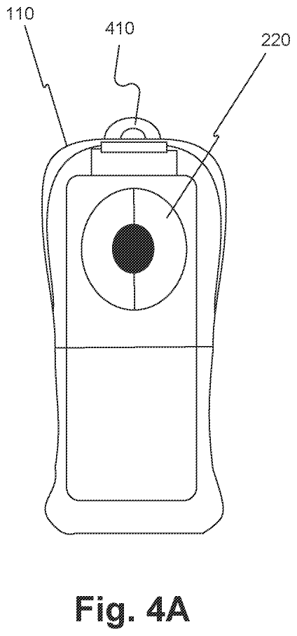

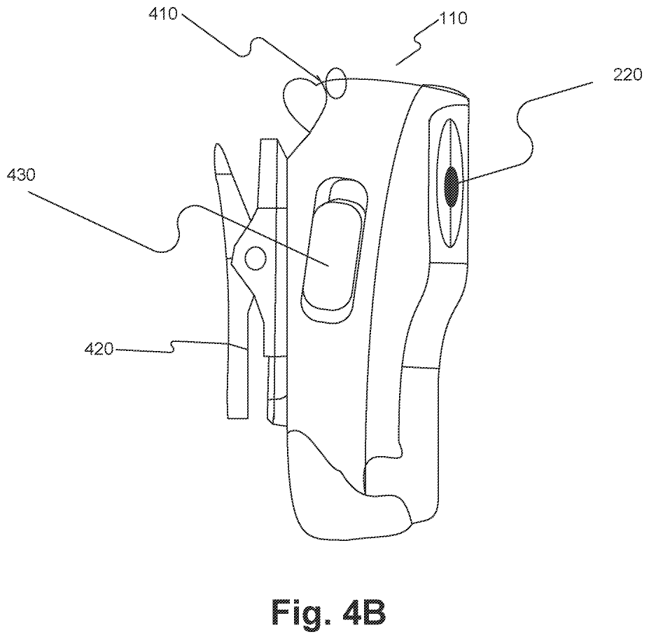

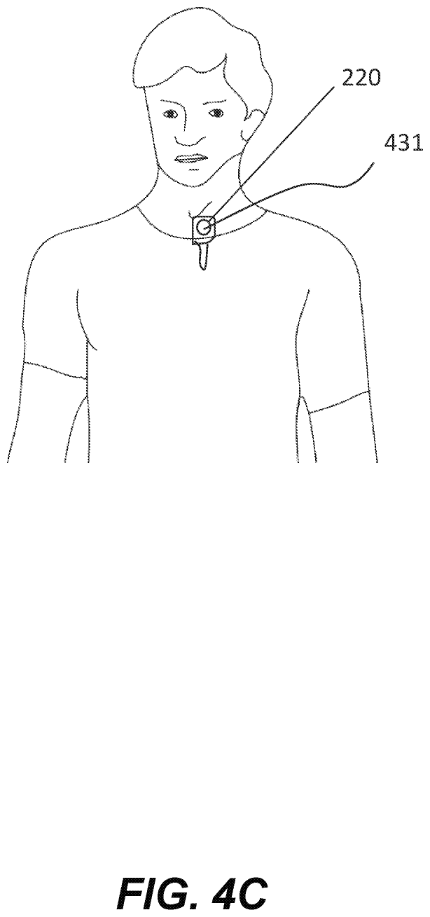

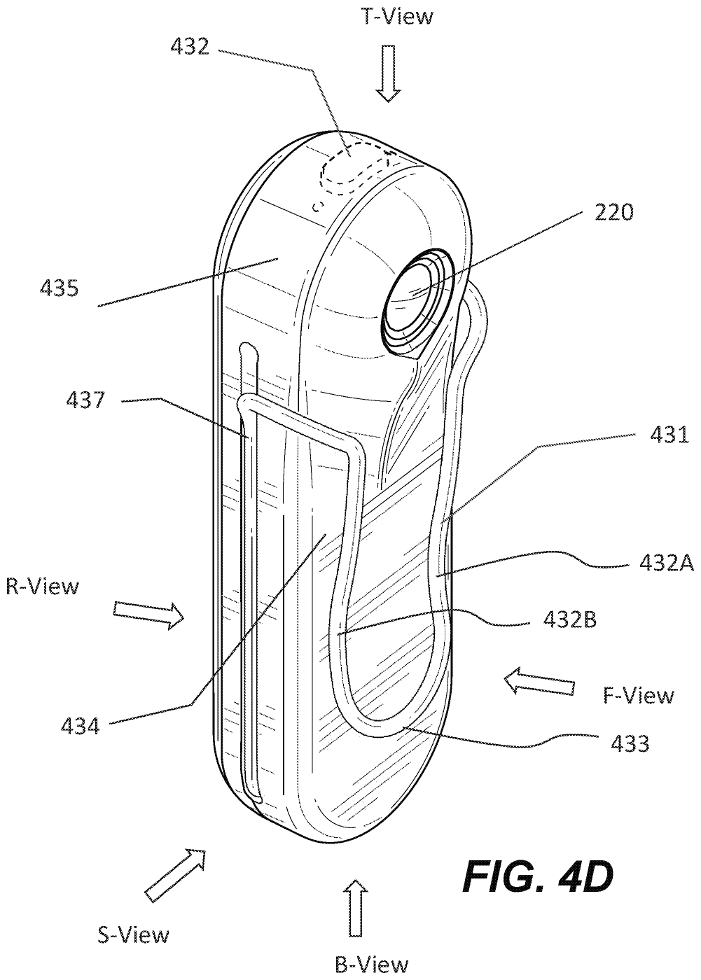

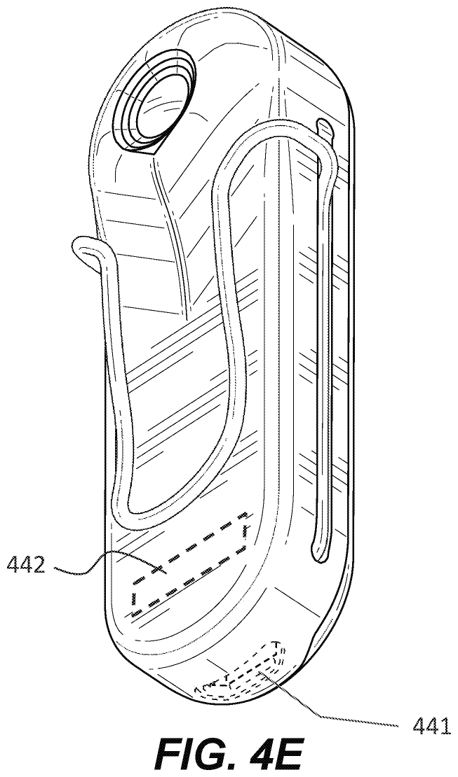

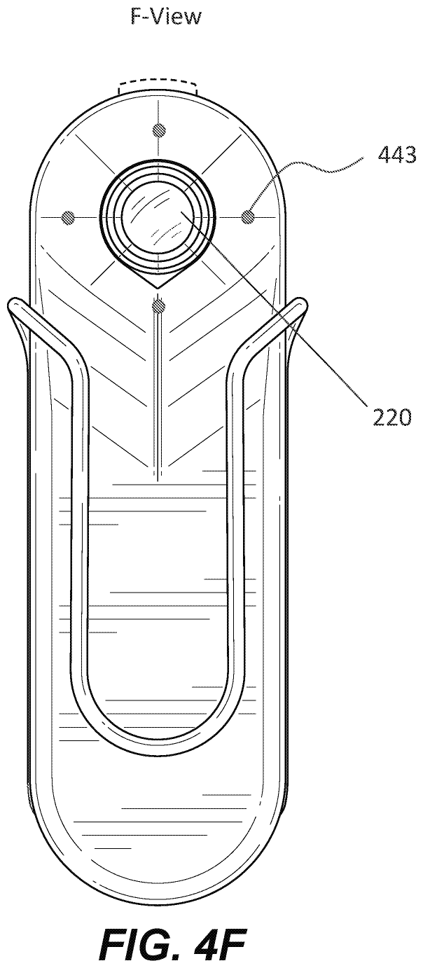

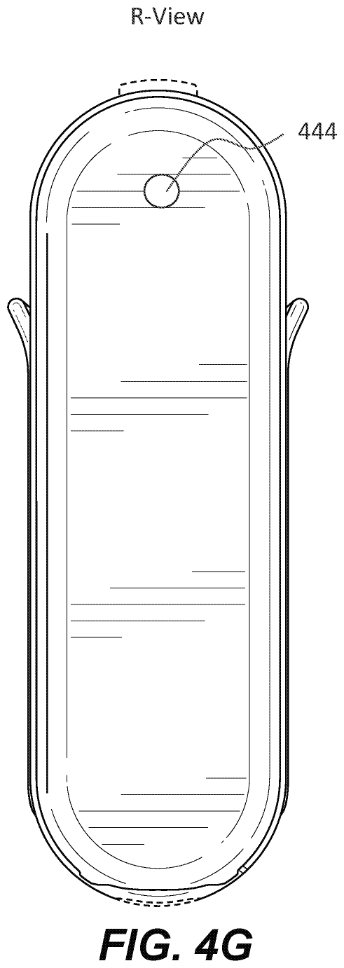

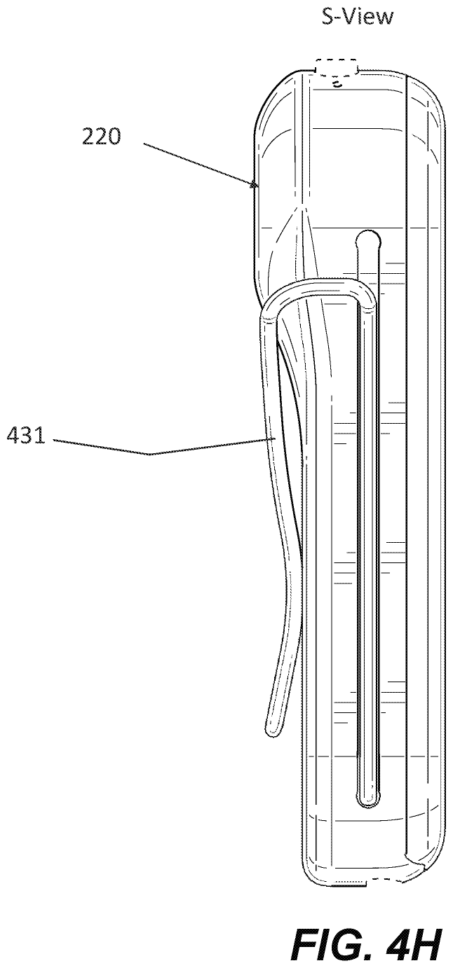

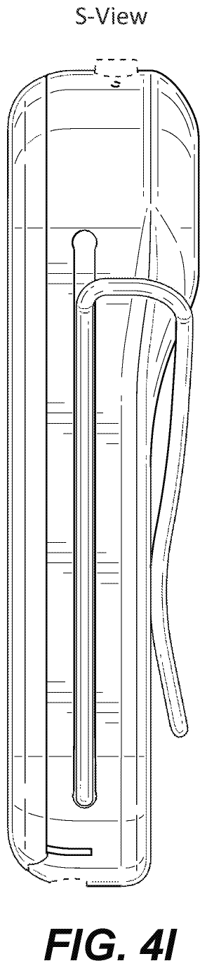

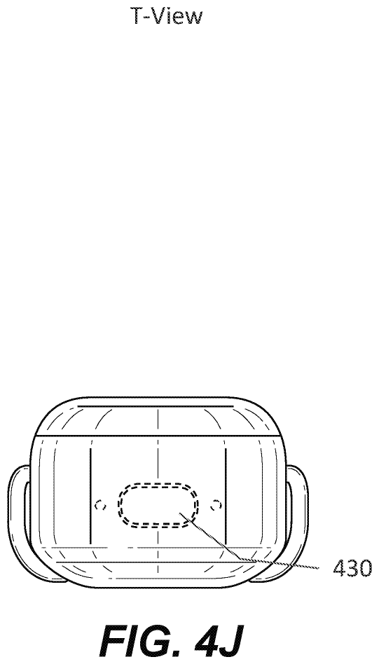

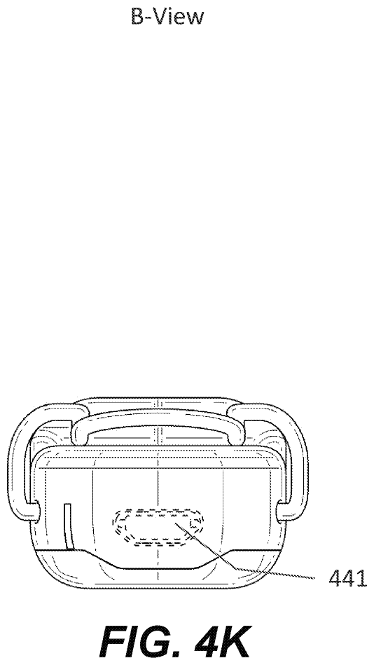

In some embodiments, apparatus 110 may be implemented in a form other than wearable glasses, as described above with respect to FIGS. 1B-1D, for example. FIG. 4A is a schematic illustration of an example of an additional embodiment of apparatus 110 from a front viewpoint of apparatus 110. Apparatus 110 includes an image sensor 220, a clip (not shown), a function button (not shown) and a hanging ring 410 for attaching apparatus 110 to, for example, necklace 140, as shown in FIG. 1B. When apparatus 110 hangs on necklace 140, the aiming direction of image sensor 220 may not fully coincide with the field-of-view of user 100, but the aiming direction would still correlate with the field-of-view of user 100.

FIG. 4B is a schematic illustration of the example of a second embodiment of apparatus 110, from a side orientation of apparatus 110. In addition to hanging ring 410, as shown in FIG. 4B, apparatus 110 may further include a clip 420. User 100 can use clip 420 to attach apparatus 110 to a shirt or belt 150, as illustrated in FIG. 1C. Clip 420 may provide an easy mechanism for disengaging and reengaging apparatus 110 from different articles of clothing. In other embodiments, apparatus 110 may include a female receptacle for connecting with a male latch of a car mount or universal stand.

In some embodiments, apparatus 110 includes a function button 430 for enabling user 100 to provide input to apparatus 110. Function button 430 may accept different types of tactile input (e.g., a tap, a click, a double-click, a long press, a right-to-left slide, a left-to-right slide). In some embodiments, each type of input may be associated with a different action. For example, a tap may be associated with the function of taking a picture, while a right-to-left slide may be associated with the function of recording a video.

Apparatus 110 may be attached to an article of clothing (e.g., a shirt, a belt, pants, etc.), of user 100 at an edge of the clothing using a clip 431 as shown in FIG. 4C. For example, the body of apparatus 100 may reside adjacent to the inside surface of the clothing with clip 431 engaging with the outside surface of the clothing. In such an embodiment, as shown in FIG. 4C, the image sensor 220 (e.g., a camera for visible light) may be protruding beyond the edge of the clothing. Alternatively, clip 431 may be engaging with the inside surface of the clothing with the body of apparatus 110 being adjacent to the outside of the clothing. In various embodiments, the clothing may be positioned between clip 431 and the body of apparatus 110.

An example embodiment of apparatus 110 is shown in FIG. 4D. Apparatus 110 includes clip 431 which may include points (e.g., 432A and 432B) in close proximity to a front surface 434 of a body 435 of apparatus 110. In an example embodiment, the distance between points 432A, 432B and front surface 434 may be less than a typical thickness of a fabric of the clothing of user 100. For example, the distance between points 432A, 432B and surface 434 may be less than a thickness of a tee-shirt, e.g., less than a millimeter, less than 2 millimeters, less than 3 millimeters, etc., or, in some cases, points 432A, 432B of clip 431 may touch surface 434. In various embodiments, clip 431 may include a point 433 that does not touch surface 434, allowing the clothing to be inserted between clip 431 and surface 434.

FIG. 4D shows schematically different views of apparatus 110 defined as a front view (F-view), a rearview (R-view), a top view (T-view), a side view (S-view) and a bottom view (B-view). These views will be referred to when describing apparatus 110 in subsequent figures. FIG. 4D shows an example embodiment where clip 431 is positioned at the same side of apparatus 110 as sensor 220 (e.g., the front side of apparatus 110). Alternatively, clip 431 may be positioned at an opposite side of apparatus 110 as sensor 220 (e.g., the rear side of apparatus 110). In various embodiments, apparatus 110 may include function button 430, as shown in FIG. 4D.

Various views of apparatus 110 are illustrated in FIGS. 4E through 4K. For example, FIG. 4E shows a view of apparatus 110 with an electrical connection 441. Electrical connection 441 may be, for example, a USB port, that may be used to transfer data to/from apparatus 110 and provide electrical power to apparatus 110. In an example embodiment, connection 441 may be used to charge a battery 442 schematically shown in FIG. 4E. FIG. 4F shows F-view of apparatus 110, including sensor 220 and one or more microphones 443. In some embodiments, apparatus 110 may include several microphones 443 facing outwards, wherein microphones 443 are configured to obtain environmental sounds and sounds of various speakers communicating with user 100. FIG. 4G shows R-view of apparatus 110. In some embodiments, microphone 444 may be positioned at the rear side of apparatus 110, as shown in FIG. 4G. Microphone 444 may be used to detect an audio signal from user 100. It should be noted, that apparatus 110 may have microphones placed at any side (e.g., a front side, a rear side, a left side, a right side, a top side, or a bottom side) of apparatus 110. In various embodiments, some microphones may be at a first side (e.g., microphones 443 may be at the front of apparatus 110) and other microphones may be at a second side (e.g., microphone 444 may be at the back side of apparatus 110).

FIGS. 4H and 41 show different sides of apparatus 110 (i.e., S-view of apparatus 110) consisted with disclosed embodiments. For example, FIG. 4H shows the location of sensor 220 and an example shape of clip 431. FIG. 4J shows T-view of apparatus 110, including function button 430, and FIG. 4K shows B-view of apparatus 110 with electrical connection 441.

The example embodiments discussed above with respect to FIGS. 3A, 3B, 4A, and 4B are not limiting. In some embodiments, apparatus 110 may be implemented in any suitable configuration for performing the disclosed methods. For example, referring back to FIG. 2, the disclosed embodiments may implement an apparatus 110 according to any configuration including an image sensor 220 and a processor unit 210 to perform image analysis and for communicating with a feedback unit 230.

FIG. 5A is a block diagram illustrating the components of apparatus 110 according to an example embodiment. As shown in FIG. 5A, and as similarly discussed above, apparatus 110 includes an image sensor 220, a memory 550, a processor 210, a feedback outputting unit 230, a wireless transceiver 530, and a mobile power source 520. In other embodiments, apparatus 110 may also include buttons, other sensors such as a microphone, and inertial measurements devices such as accelerometers, gyroscopes, magnetometers, temperature sensors, color sensors, light sensors, etc. Apparatus 110 may further include a data port 570 and a power connection 510 with suitable interfaces for connecting with an external power source or an external device (not shown).

Processor 210, depicted in FIG. 5A, may include any suitable processing device. The term “processing device” includes any physical device having an electric circuit that performs a logic operation on input or inputs. For example, processing device may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by the processing device may, for example, be pre-loaded into a memory integrated with or embedded into the processing device or may be stored in a separate memory (e.g., memory 550). Memory 550 may comprise a Random Access Memory (RAM), a Read-Only Memory (ROM), a hard disk, an optical disk, a magnetic medium, a flash memory, other permanent, fixed, or volatile memory, or any other mechanism capable of storing instructions.

Although, in the embodiment illustrated in FIG. 5A, apparatus 110 includes one processing device (e.g., processor 210), apparatus 110 may include more than one processing device. Each processing device may have a similar construction, or the processing devices may be of differing constructions that are electrically connected or disconnected from each other. For example, the processing devices may be separate circuits or integrated in a single circuit. When more than one processing device is used, the processing devices may be configured to operate independently or collaboratively. The processing devices may be coupled electrically, magnetically, optically, acoustically, mechanically or by other means that permit them to interact.

In some embodiments, processor 210 may process a plurality of images captured from the environment of user 100 to determine different parameters related to capturing subsequent images. For example, processor 210 can determine, based on information derived from captured image data, a value for at least one of the following: an image resolution, a compression ratio, a cropping parameter, frame rate, a focus point, an exposure time, an aperture size, and a light sensitivity. The determined value may be used in capturing at least one subsequent image. Additionally, processor 210 can detect images including at least one hand-related trigger in the environment of the user and perform an action and/or provide an output of information to a user via feedback outputting unit 230.

In another embodiment, processor 210 can change the aiming direction of image sensor 220. For example, when apparatus 110 is attached with clip 420, the aiming direction of image sensor 220 may not coincide with the field-of-view of user 100. Processor 210 may recognize certain situations from the analyzed image data and adjust the aiming direction of image sensor 220 to capture relevant image data. For example, in one embodiment, processor 210 may detect an interaction with another individual and sense that the individual is not fully in view, because image sensor 220 is tilted down. Responsive thereto, processor 210 may adjust the aiming direction of image sensor 220 to capture image data of the individual. Other scenarios are also contemplated where processor 210 may recognize the need to adjust an aiming direction of image sensor 220.

In some embodiments, processor 210 may communicate data to feedback-outputting unit 230, which may include any device configured to provide information to a user 100. Feedback outputting unit 230 may be provided as part of apparatus 110 (as shown) or may be provided external to apparatus 110 and communicatively coupled thereto. Feedback-outputting unit 230 may be configured to output visual or nonvisual feedback based on signals received from processor 210, such as when processor 210 recognizes a hand-related trigger in the analyzed image data.

The term “feedback” refers to any output or information provided in response to processing at least one image in an environment. In some embodiments, as similarly described above, feedback may include an audible or visible indication of time information, detected text or numerals, the value of currency, a branded product, a person's identity, the identity of a landmark or other environmental situation or condition including the street names at an intersection or the color of a traffic light, etc., as well as other information associated with each of these. For example, in some embodiments, feedback may include additional information regarding the amount of currency still needed to complete a transaction, information regarding the identified person, historical information or times and prices of admission etc. of a detected landmark etc. In some embodiments, feedback may include an audible tone, a tactile response, and/or information previously recorded by user 100. Feedback-outputting unit 230 may comprise appropriate components for outputting acoustical and tactile feedback. For example, feedback-outputting unit 230 may comprise audio headphones, a hearing aid type device, a speaker, a bone conduction headphone, interfaces that provide tactile cues, vibrotactile stimulators, etc. In some embodiments, processor 210 may communicate signals with an external feedback outputting unit 230 via a wireless transceiver 530, a wired connection, or some other communication interface. In some embodiments, feedback outputting unit 230 may also include any suitable display device for visually displaying information to user 100.

As shown in FIG. 5A, apparatus 110 includes memory 550. Memory 550 may include one or more sets of instructions accessible to processor 210 to perform the disclosed methods, including instructions for recognizing a hand-related trigger in the image data. In some embodiments memory 550 may store image data (e.g., images, videos) captured from the environment of user 100. In addition, memory 550 may store information specific to user 100, such as image representations of known individuals, favorite products, personal items, and calendar or appointment information, etc. In some embodiments, processor 210 may determine, for example, which type of image data to store based on available storage space in memory 550. In another embodiment, processor 210 may extract information from the image data stored in memory 550.

As further shown in FIG. 5A, apparatus 110 includes mobile power source 520. The term “mobile power source” includes any device capable of providing electrical power, which can be easily carried by hand (e.g., mobile power source 520 may weigh less than a pound). The mobility of the power source enables user 100 to use apparatus 110 in a variety of situations. In some embodiments, mobile power source 520 may include one or more batteries (e.g., nickel-cadmium batteries, nickel-metal hydride batteries, and lithium-ion batteries) or any other type of electrical power supply. In other embodiments, mobile power source 520 may be rechargeable and contained within a casing that holds apparatus 110. In yet other embodiments, mobile power source 520 may include one or more energy harvesting devices for converting ambient energy into electrical energy (e.g., portable solar power units, human vibration units, etc.).

Mobile power source 520 may power one or more wireless transceivers (e.g., wireless transceiver 530 in FIG. 5A). The term “wireless transceiver” refers to any device configured to exchange transmissions over an air interface by use of radio frequency, infrared frequency, magnetic field, or electric field. Wireless transceiver 530 may use any known standard to transmit and/or receive data (e.g., Wi-Fi, Bluetooth®, Bluetooth Smart, 802.15.4, or ZigBee). In some embodiments, wireless transceiver 530 may transmit data (e.g., raw image data, processed image data, extracted information) from apparatus 110 to computing device 120 and/or server 250. Wireless transceiver 530 may also receive data from computing device 120 and/or server 250. In other embodiments, wireless transceiver 530 may transmit data and instructions to an external feedback outputting unit 230.

FIG. 5B is a block diagram illustrating the components of apparatus 110 according to another example embodiment. In some embodiments, apparatus 110 includes a first image sensor 220a, a second image sensor 220b, a memory 550, a first processor 210a, a second processor 210b, a feedback outputting unit 230, a wireless transceiver 530, a mobile power source 520, and a power connector 510. In the arrangement shown in FIG. 5B, each of the image sensors may provide images in a different image resolution, or face a different direction. Alternatively, each image sensor may be associated with a different camera (e.g., a wide angle camera, a narrow angle camera, an IR camera, etc.). In some embodiments, apparatus 110 can select which image sensor to use based on various factors. For example, processor 210a may determine, based on available storage space in memory 550, to capture subsequent images in a certain resolution.

Apparatus 110 may operate in a first processing-mode and in a second processing-mode, such that the first processing-mode may consume less power than the second processing-mode. For example, in the first processing-mode, apparatus 110 may capture images and process the captured images to make real-time decisions based on an identifying hand-related trigger, for example. In the second processing-mode, apparatus 110 may extract information from stored images in memory 550 and delete images from memory 550. In some embodiments, mobile power source 520 may provide more than fifteen hours of processing in the first processing-mode and about three hours of processing in the second processing-mode. Accordingly, different processing-modes may allow mobile power source 520 to produce sufficient power for powering apparatus 110 for various time periods (e.g., more than two hours, more than four hours, more than ten hours, etc.).

In some embodiments, apparatus 110 may use first processor 210a in the first processing-mode when powered by mobile power source 520, and second processor 210b in the second processing-mode when powered by external power source 580 that is connectable via power connector 510. In other embodiments, apparatus 110 may determine, based on predefined conditions, which processors or which processing modes to use. Apparatus 110 may operate in the second processing-mode even when apparatus 110 is not powered by external power source 580. For example, apparatus 110 may determine that it should operate in the second processing-mode when apparatus 110 is not powered by external power source 580, if the available storage space in memory 550 for storing new image data is lower than a predefined threshold.

Although one wireless transceiver is depicted in FIG. 5B, apparatus 110 may include more than one wireless transceiver (e.g., two wireless transceivers). In an arrangement with more than one wireless transceiver, each of the wireless transceivers may use a different standard to transmit and/or receive data. In some embodiments, a first wireless transceiver may communicate with server 250 or computing device 120 using a cellular standard (e.g., LTE or GSM), and a second wireless transceiver may communicate with server 250 or computing device 120 using a short-range standard (e.g., Wi-Fi or Bluetooth®). In some embodiments, apparatus 110 may use the first wireless transceiver when the wearable apparatus is powered by a mobile power source included in the wearable apparatus, and use the second wireless transceiver when the wearable apparatus is powered by an external power source.

FIG. 5C is a block diagram illustrating the components of apparatus 110 according to another example embodiment including computing device 120. In this embodiment, apparatus 110 includes an image sensor 220, a memory 550a, a first processor 210, a feedback-outputting unit 230, a wireless transceiver 530a, a mobile power source 520, and a power connector 510. As further shown in FIG. 5C, computing device 120 includes a processor 540, a feedback-outputting unit 545, a memory 550b, a wireless transceiver 530b, and a display 260. One example of computing device 120 is a smartphone or tablet having a dedicated application installed therein. In other embodiments, computing device 120 may include any configuration such as an on-board automobile computing system, a PC, a laptop, and any other system consistent with the disclosed embodiments. In this example, user 100 may view feedback output in response to identification of a hand-related trigger on display 260. Additionally, user 100 may view other data (e.g., images, video clips, object information, schedule information, extracted information, etc.) on display 260. In addition, user 100 may communicate with server 250 via computing device 120.

In some embodiments, processor 210 and processor 540 are configured to extract information from captured image data. The term “extracting information” includes any process by which information associated with objects, individuals, locations, events, etc., is identified in the captured image data by any means known to those of ordinary skill in the art. In some embodiments, apparatus 110 may use the extracted information to send feedback or other real-time indications to feedback outputting unit 230 or to computing device 120. In some embodiments, processor 210 may identify in the image data the individual standing in front of user 100, and send computing device 120 the name of the individual and the last time user 100 met the individual. In another embodiment, processor 210 may identify in the image data, one or more visible triggers, including a hand-related trigger, and determine whether the trigger is associated with a person other than the user of the wearable apparatus to selectively determine whether to perform an action associated with the trigger. One such action may be to provide a feedback to user 100 via feedback-outputting unit 230 provided as part of (or in communication with) apparatus 110 or via a feedback unit 545 provided as part of computing device 120. For example, feedback-outputting unit 545 may be in communication with display 260 to cause the display 260 to visibly output information. In some embodiments, processor 210 may identify in the image data a hand-related trigger and send computing device 120 an indication of the trigger. Processor 540 may then process the received trigger information and provide an output via feedback outputting unit 545 or display 260 based on the hand-related trigger. In other embodiments, processor 540 may determine a hand-related trigger and provide suitable feedback similar to the above, based on image data received from apparatus 110. In some embodiments, processor 540 may provide instructions or other information, such as environmental information to apparatus 110 based on an identified hand-related trigger.

In some embodiments, processor 210 may identify other environmental information in the analyzed images, such as an individual standing in front user 100, and send computing device 120 information related to the analyzed information such as the name of the individual and the last time user 100 met the individual. In a different embodiment, processor 540 may extract statistical information from captured image data and forward the statistical information to server 250. For example, certain information regarding the types of items a user purchases, or the frequency a user patronizes a particular merchant, etc. may be determined by processor 540. Based on this information, server 250 may send computing device 120 coupons and discounts associated with the user's preferences.

When apparatus 110 is connected or wirelessly connected to computing device 120, apparatus 110 may transmit at least part of the image data stored in memory 550a for storage in memory 550b. In some embodiments, after computing device 120 confirms that transferring the part of image data was successful, processor 540 may delete the part of the image data. The term “delete” means that the image is marked as ‘deleted’ and other image data may be stored instead of it, but does not necessarily mean that the image data was physically removed from the memory.

As will be appreciated by a person skilled in the art having the benefit of this disclosure, numerous variations and/or modifications may be made to the disclosed embodiments. Not all components are essential for the operation of apparatus 110. Any component may be located in any appropriate apparatus and the components may be rearranged into a variety of configurations while providing the functionality of the disclosed embodiments. For example, in some embodiments, apparatus 110 may include a camera, a processor, and a wireless transceiver for sending data to another device. Therefore, the foregoing configurations are examples and, regardless of the configurations discussed above, apparatus 110 can capture, store, and/or process images.

Further, the foregoing and following description refers to storing and/or processing images or image data. In the embodiments disclosed herein, the stored and/or processed images or image data may comprise a representation of one or more images captured by image sensor 220. As the term is used herein, a “representation” of an image (or image data) may include an entire image or a portion of an image. A representation of an image (or image data) may have the same resolution or a lower resolution as the image (or image data), and/or a representation of an image (or image data) may be altered in some respect (e.g., be compressed, have a lower resolution, have one or more colors that are altered, etc.).

For example, apparatus 110 may capture an image and store a representation of the image that is compressed as a .JPG file. As another example, apparatus 110 may capture an image in color, but store a black-and-white representation of the color image. As yet another example, apparatus 110 may capture an image and store a different representation of the image (e.g., a portion of the image). For example, apparatus 110 may store a portion of an image that includes a face of a person who appears in the image, but that does not substantially include the environment surrounding the person. Similarly, apparatus 110 may, for example, store a portion of an image that includes a product that appears in the image, but does not substantially include the environment surrounding the product. As yet another example, apparatus 110 may store a representation of an image at a reduced resolution (i.e., at a resolution that is of a lower value than that of the captured image). Storing representations of images may allow apparatus 110 to save storage space in memory 550. Furthermore, processing representations of images may allow apparatus 110 to improve processing efficiency and/or help to preserve battery life.

In addition to the above, in some embodiments, any one of apparatus 110 or computing device 120, via processor 210 or 540, may further process the captured image data to provide additional functionality to recognize objects and/or gestures and/or other information in the captured image data. In some embodiments, actions may be taken based on the identified objects, gestures, or other information. In some embodiments, processor 210 or 540 may identify in the image data, one or more visible triggers, including a hand-related trigger, and determine whether the trigger is associated with a person other than the user to determine whether to perform an action associated with the trigger.

Some embodiments of the present disclosure may include an apparatus securable to an article of clothing of a user. Such an apparatus may include two portions, connectable by a connector. A capturing unit may be designed to be worn on the outside of a user's clothing, and may include an image sensor for capturing images of a user's environment. The capturing unit may be connected to or connectable to a power unit, which may be configured to house a power source and a processing device. The capturing unit may be a small device including a camera or other device for capturing images. The capturing unit may be designed to be inconspicuous and unobtrusive, and may be configured to communicate with a power unit concealed by a user's clothing. The power unit may include bulkier aspects of the system, such as transceiver antennas, at least one battery, a processing device, etc. In some embodiments, communication between the capturing unit and the power unit may be provided by a data cable included in the connector, while in other embodiments, communication may be wirelessly achieved between the capturing unit and the power unit. Some embodiments may permit alteration of the orientation of an image sensor of the capture unit, for example to better capture images of interest.

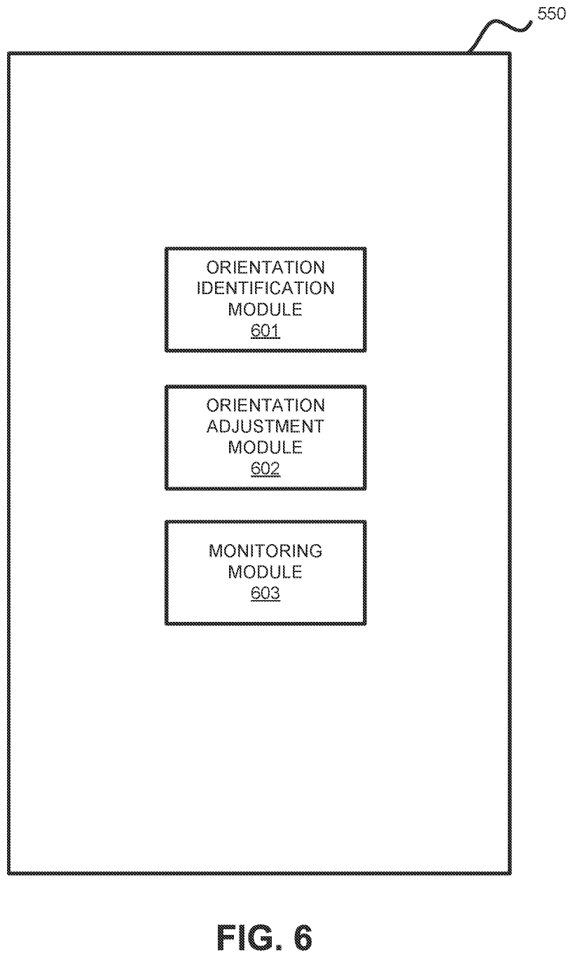

FIG. 6 illustrates an exemplary embodiment of a memory containing software modules consistent with the present disclosure. Included in memory 550 are orientation identification module 601, orientation adjustment module 602, and motion tracking module 603. Modules 601, 602, 603 may contain software instructions for execution by at least one processing device, e.g., processor 210, included with a wearable apparatus. Orientation identification module 601, orientation adjustment module 602, and motion tracking module 603 may cooperate to provide orientation adjustment for a capturing unit incorporated into wireless apparatus 110.

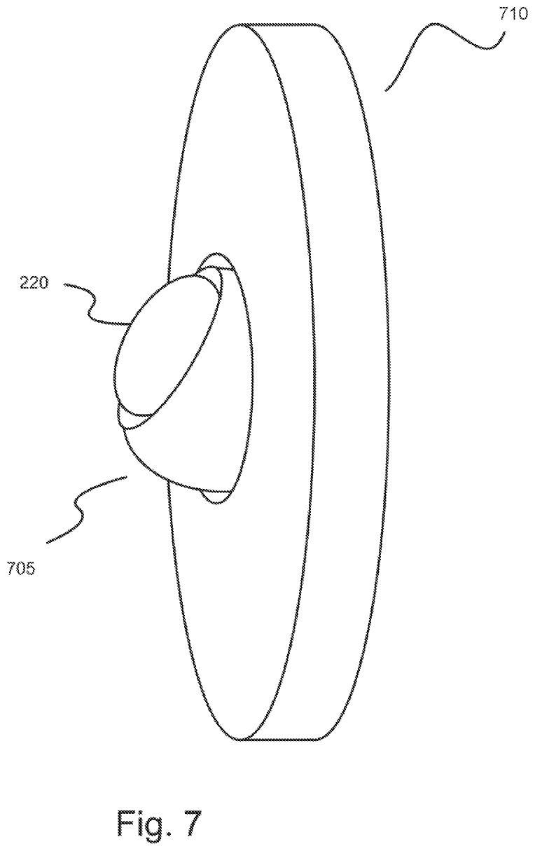

FIG. 7 illustrates an exemplary capturing unit 710 including an orientation adjustment unit 705. Orientation adjustment unit 705 may be configured to permit the adjustment of image sensor 220. As illustrated in FIG. 7, orientation adjustment unit 705 may include an eye-ball type adjustment mechanism. In alternative embodiments, orientation adjustment unit 705 may include gimbals, adjustable stalks, pivotable mounts, and any other suitable unit for adjusting an orientation of image sensor 220.

Image sensor 220 may be configured to be movable with the head of user 100 in such a manner that an aiming direction of image sensor 220 substantially coincides with a field of view of user 100. For example, as described above, a camera associated with image sensor 220 may be installed within capturing unit 710 at a predetermined angle in a position facing slightly upwards or downwards, depending on an intended location of capturing unit 710. Accordingly, the set aiming direction of image sensor 220 may match the field-of-view of user 100. In some embodiments, processor 210 may change the orientation of image sensor 220 using image data provided from image sensor 220. For example, processor 210 may recognize that a user is reading a book and determine that the aiming direction of image sensor 220 is offset from the text. That is, because the words in the beginning of each line of text are not fully in view, processor 210 may determine that image sensor 220 is tilted in the wrong direction. Responsive thereto, processor 210 may adjust the aiming direction of image sensor 220.

Orientation identification module 601 may be configured to identify an orientation of an image sensor 220 of capturing unit 710. An orientation of an image sensor 220 may be identified, for example, by analysis of images captured by image sensor 220 of capturing unit 710, by tilt or attitude sensing devices within capturing unit 710, and by measuring a relative direction of orientation adjustment unit 705 with respect to the remainder of capturing unit 710.

Orientation adjustment module 602 may be configured to adjust an orientation of image sensor 220 of capturing unit 710. As discussed above, image sensor 220 may be mounted on an orientation adjustment unit 705 configured for movement. Orientation adjustment unit 705 may be configured for rotational and/or lateral movement in response to commands from orientation adjustment module 602. In some embodiments orientation adjustment unit 705 may be adjust an orientation of image sensor 220 via motors, electromagnets, permanent magnets, and/or any suitable combination thereof.

In some embodiments, monitoring module 603 may be provided for continuous monitoring. Such continuous monitoring may include tracking a movement of at least a portion of an object included in one or more images captured by the image sensor. For example, in one embodiment, apparatus 110 may track an object as long as the object remains substantially within the field-of-view of image sensor 220. In additional embodiments, monitoring module 603 may engage orientation adjustment module 602 to instruct orientation adjustment unit 705 to continually orient image sensor 220 towards an object of interest. For example, in one embodiment, monitoring module 603 may cause image sensor 220 to adjust an orientation to ensure that a certain designated object, for example, the face of a particular person, remains within the field-of view of image sensor 220, even as that designated object moves about. In another embodiment, monitoring module 603 may continuously monitor an area of interest included in one or more images captured by the image sensor. For example, a user may be occupied by a certain task, for example, typing on a laptop, while image sensor 220 remains oriented in a particular direction and continuously monitors a portion of each image from a series of images to detect a trigger or other event. For example, image sensor 210 may be oriented towards a piece of laboratory equipment and monitoring module 603 may be configured to monitor a status light on the laboratory equipment for a change in status, while the user's attention is otherwise occupied.

In some embodiments consistent with the present disclosure, capturing unit 710 may include a plurality of image sensors 220. The plurality of image sensors 220 may each be configured to capture different image data. For example, when a plurality of image sensors 220 are provided, the image sensors 220 may capture images having different resolutions, may capture wider or narrower fields of view, and may have different levels of magnification. Image sensors 220 may be provided with varying lenses to permit these different configurations. In some embodiments, a plurality of image sensors 220 may include image sensors 220 having different orientations. Thus, each of the plurality of image sensors 220 may be pointed in a different direction to capture different images. The fields of view of image sensors 220 may be overlapping in some embodiments. The plurality of image sensors 220 may each be configured for orientation adjustment, for example, by being paired with an image adjustment unit 705. In some embodiments, monitoring module 603, or another module associated with memory 550, may be configured to individually adjust the orientations of the plurality of image sensors 220 as well as to turn each of the plurality of image sensors 220 on or off as may be required. In some embodiments, monitoring an object or person captured by an image sensor 220 may include tracking movement of the object across the fields of view of the plurality of image sensors 220.

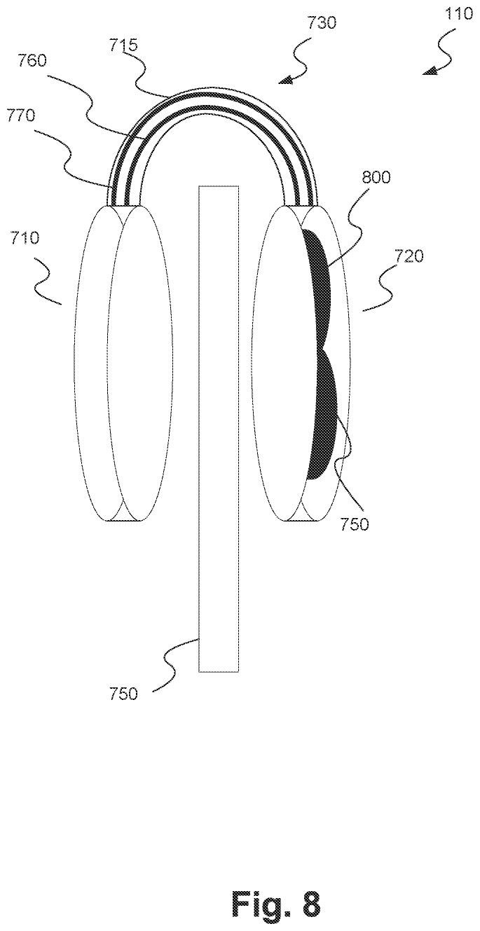

Embodiments consistent with the present disclosure may include connectors configured to connect a capturing unit and a power unit of a wearable apparatus. Capturing units consistent with the present disclosure may include least one image sensor configured to capture images of an environment of a user. Power units consistent with the present disclosure may be configured to house a power source and/or at least one processing device. Connectors consistent with the present disclosure may be configured to connect the capturing unit and the power unit, and may be configured to secure the apparatus to an article of clothing such that the capturing unit is positioned over an outer surface of the article of clothing and the power unit is positioned under an inner surface of the article of clothing Exemplary embodiments of capturing units, connectors, and power units consistent with the disclosure are discussed in further detail with respect to FIGS. 8-14.

FIG. 8 is a schematic illustration of an embodiment of wearable apparatus 110 securable to an article of clothing consistent with the present disclosure. As illustrated in FIG. 8, capturing unit 710 and power unit 720 may be connected by a connector 730 such that capturing unit 710 is positioned on one side of an article of clothing 750 and power unit 720 is positioned on the opposite side of the clothing 750. In some embodiments, capturing unit 710 may be positioned over an outer surface of the article of clothing 750 and power unit 720 may be located under an inner surface of the article of clothing 750. The power unit 720 may be configured to be placed against the skin of a user.

Capturing unit 710 may include an image sensor 220 and an orientation adjustment unit 705 (as illustrated in FIG. 7). Power unit 720 may include mobile power source 520 and processor 210. Power unit 720 may further include any combination of elements previously discussed that may be a part of wearable apparatus 110, including, but not limited to, wireless transceiver 530, feedback outputting unit 230, memory 550, and data port 570.

Connector 730 may include a clip 715 or other mechanical connection designed to clip or attach capturing unit 710 and power unit 720 to an article of clothing 750 as illustrated in FIG. 8. As illustrated, clip 715 may connect to each of capturing unit 710 and power unit 720 at a perimeter thereof, and may wrap around an edge of the article of clothing 750 to affix the capturing unit 710 and power unit 720 in place. Connector 730 may further include a power cable 760 and a data cable 770. Power cable 760 may be capable of conveying power from mobile power source 520 to image sensor 220 of capturing unit 710. Power cable 760 may also be configured to provide power to any other elements of capturing unit 710, e.g., orientation adjustment unit 705. Data cable 770 may be capable of conveying captured image data from image sensor 220 in capturing unit 710 to processor 800 in the power unit 720. Data cable 770 may be further capable of conveying additional data between capturing unit 710 and processor 800, e.g., control instructions for orientation adjustment unit 705.

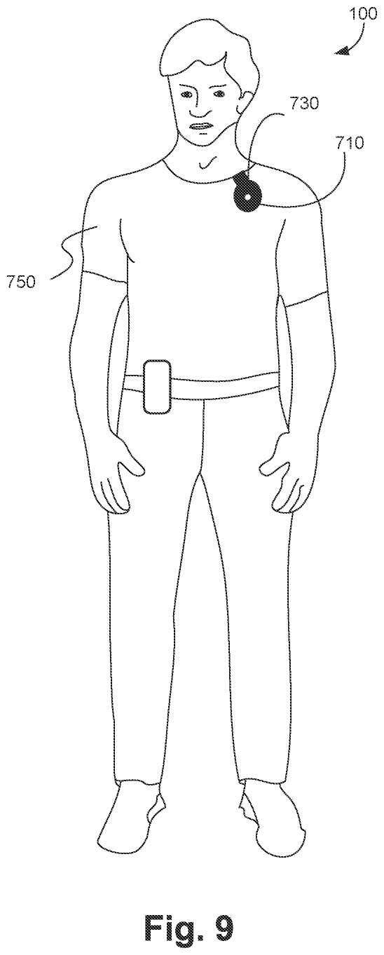

FIG. 9 is a schematic illustration of a user 100 wearing a wearable apparatus 110 consistent with an embodiment of the present disclosure. As illustrated in FIG. 9, capturing unit 710 is located on an exterior surface of the clothing 750 of user 100. Capturing unit 710 is connected to power unit 720 (not seen in this illustration) via connector 730, which wraps around an edge of clothing 750.

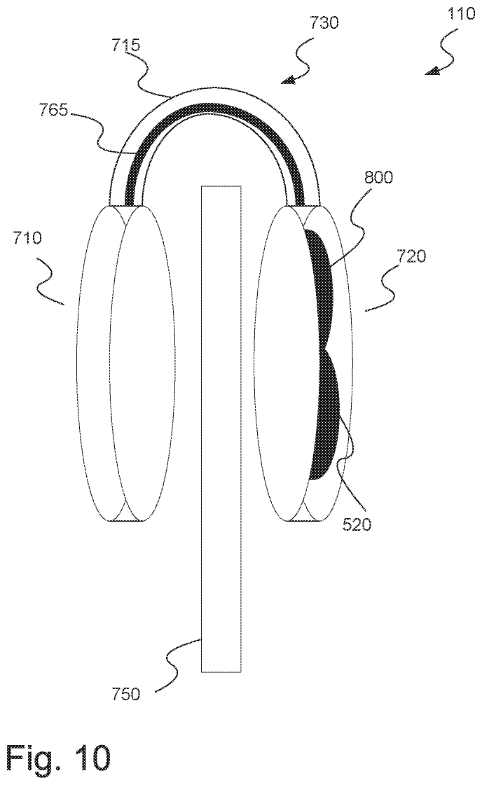

In some embodiments, connector 730 may include a flexible printed circuit board (PCB). FIG. 10 illustrates an exemplary embodiment wherein connector 730 includes a flexible printed circuit board 765. Flexible printed circuit board 765 may include data connections and power connections between capturing unit 710 and power unit 720. Thus, in some embodiments, flexible printed circuit board 765 may serve to replace power cable 760 and data cable 770. In alternative embodiments, flexible printed circuit board 765 may be included in addition to at least one of power cable 760 and data cable 770. In various embodiments discussed herein, flexible printed circuit board 765 may be substituted for, or included in addition to, power cable 760 and data cable 770.

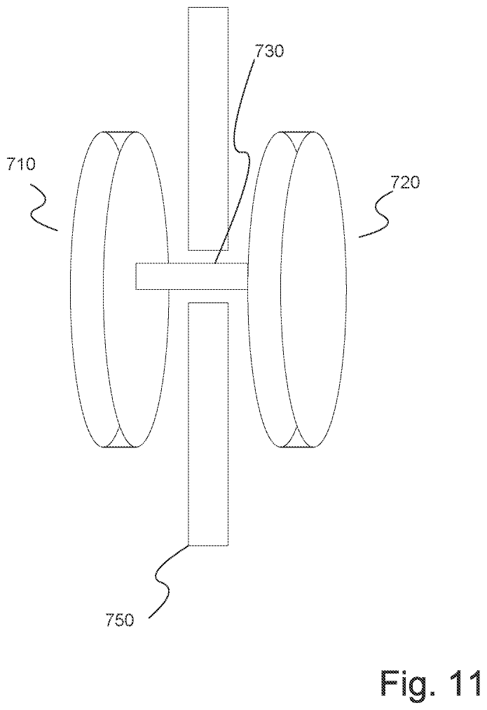

FIG. 11 is a schematic illustration of another embodiment of a wearable apparatus securable to an article of clothing consistent with the present disclosure. As illustrated in FIG. 11, connector 730 may be centrally located with respect to capturing unit 710 and power unit 720. Central location of connector 730 may facilitate affixing apparatus 110 to clothing 750 through a hole in clothing 750 such as, for example, a button-hole in an existing article of clothing 750 or a specialty hole in an article of clothing 750 designed to accommodate wearable apparatus 110.

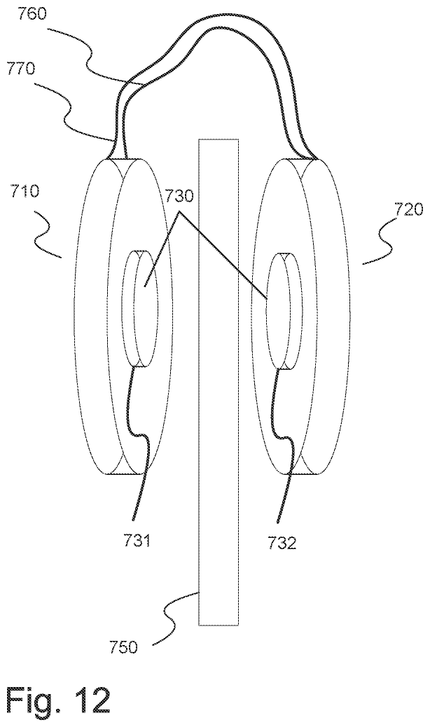

FIG. 12 is a schematic illustration of still another embodiment of wearable apparatus 110 securable to an article of clothing. As illustrated in FIG. 12, connector 730 may include a first magnet 731 and a second magnet 732. First magnet 731 and second magnet 732 may secure capturing unit 710 to power unit 720 with the article of clothing positioned between first magnet 731 and second magnet 732. In embodiments including first magnet 731 and second magnet 732, power cable 760 and data cable 770 may also be included. In these embodiments, power cable 760 and data cable 770 may be of any length, and may provide a flexible power and data connection between capturing unit 710 and power unit 720. Embodiments including first magnet 731 and second magnet 732 may further include a flexible PCB 765 connection in addition to or instead of power cable 760 and/or data cable 770. In some embodiments, first magnet 731 or second magnet 732 may be replaced by an object comprising a metal material.

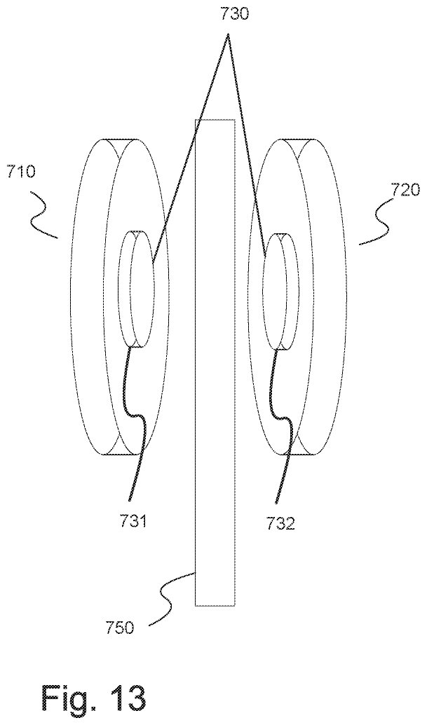

FIG. 13 is a schematic illustration of yet another embodiment of a wearable apparatus 110 securable to an article of clothing. FIG. 13 illustrates an embodiment wherein power and data may be wirelessly transferred between capturing unit 710 and power unit 720. As illustrated in FIG. 13, first magnet 731 and second magnet 732 may be provided as connector 730 to secure capturing unit 710 and power unit 720 to an article of clothing 750. Power and/or data may be transferred between capturing unit 710 and power unit 720 via any suitable wireless technology, for example, magnetic and/or capacitive coupling, near field communication technologies, radiofrequency transfer, and any other wireless technology suitable for transferring data and/or power across short distances.

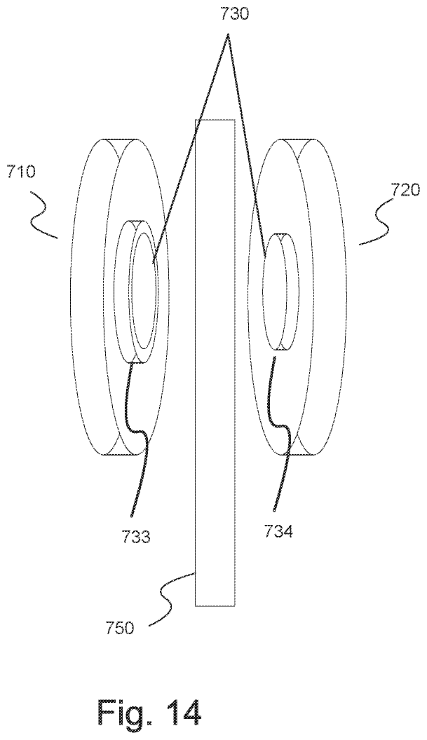

FIG. 14 illustrates still another embodiment of wearable apparatus 110 securable to an article of clothing 750 of a user. As illustrated in FIG. 14, connector 730 may include features designed for a contact fit. For example, capturing unit 710 may include a ring 733 with a hollow center having a diameter slightly larger than a disk-shaped protrusion 734 located on power unit 720. When pressed together with fabric of an article of clothing 750 between them, disk-shaped protrusion 734 may fit tightly inside ring 733, securing capturing unit 710 to power unit 720. FIG. 14 illustrates an embodiment that does not include any cabling or other physical connection between capturing unit 710 and power unit 720. In this embodiment, capturing unit 710 and power unit 720 may transfer power and data wirelessly. In alternative embodiments, capturing unit 710 and power unit 720 may transfer power and data via at least one of cable 760, data cable 770, and flexible printed circuit board 765.

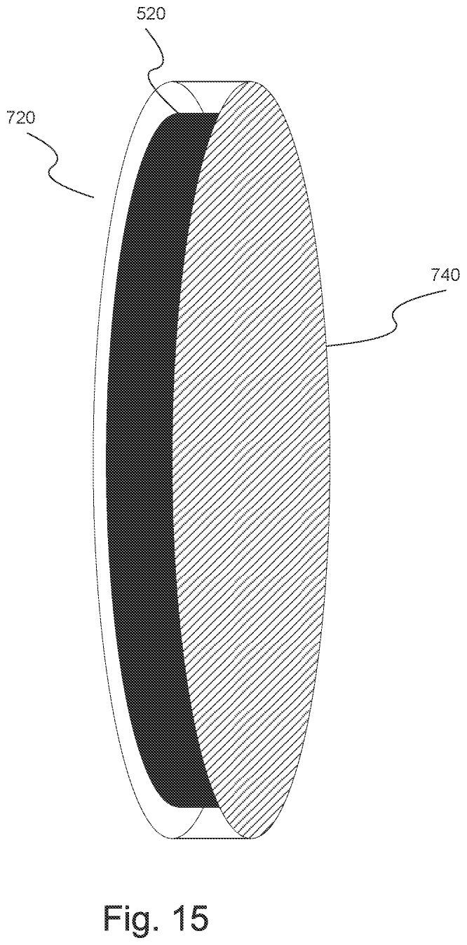

FIG. 15 illustrates another aspect of power unit 720 consistent with embodiments described herein. Power unit 720 may be configured to be positioned directly against the user's skin. To facilitate such positioning, power unit 720 may further include at least one surface coated with a biocompatible material 740. Biocompatible materials 740 may include materials that will not negatively react with the skin of the user when worn against the skin for extended periods of time. Such materials may include, for example, silicone, PTFE, kapton, polyimide, titanium, nitinol, platinum, and others. Also as illustrated in FIG. 15, power unit 720 may be sized such that an inner volume of the power unit is substantially filled by mobile power source 520. That is, in some embodiments, the inner volume of power unit 720 may be such that the volume does not accommodate any additional components except for mobile power source 520. In some embodiments, mobile power source 520 may take advantage of its close proximity to the skin of user's skin. For example, mobile power source 520 may use the Peltier effect to produce power and/or charge the power source.

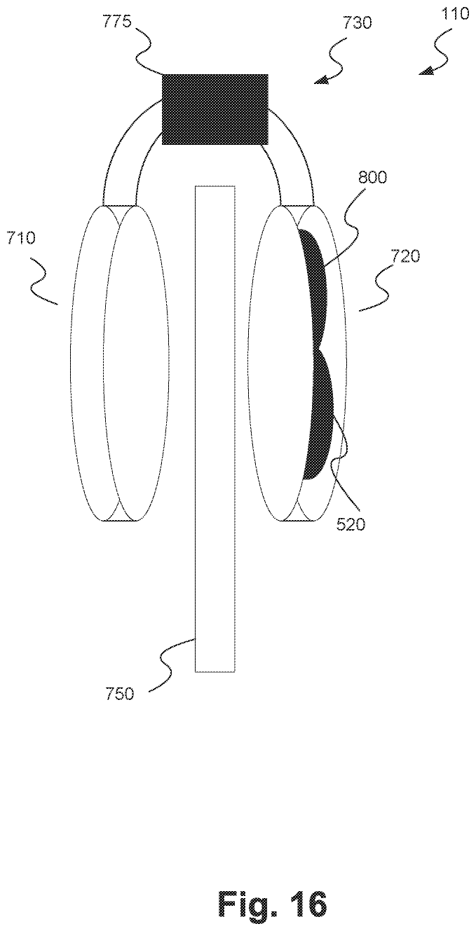

In further embodiments, an apparatus securable to an article of clothing may further include protective circuitry associated with power source 520 housed in in power unit 720. FIG. 16 illustrates an exemplary embodiment including protective circuitry 775. As illustrated in FIG. 16, protective circuitry 775 may be located remotely with respect to power unit 720. In alternative embodiments, protective circuitry 775 may also be located in capturing unit 710, on flexible printed circuit board 765, or in power unit 720.

Protective circuitry 775 may be configured to protect image sensor 220 and/or other elements of capturing unit 710 from potentially dangerous currents and/or voltages produced by mobile power source 520. Protective circuitry 775 may include passive components such as capacitors, resistors, diodes, inductors, etc., to provide protection to elements of capturing unit 710. In some embodiments, protective circuitry 775 may also include active components, such as transistors, to provide protection to elements of capturing unit 710. For example, in some embodiments, protective circuitry 775 may comprise one or more resistors serving as fuses. Each fuse may comprise a wire or strip that melts (thereby braking a connection between circuitry of image capturing unit 710 and circuitry of power unit 720) when current flowing through the fuse exceeds a predetermined limit (e.g., 500 milliamps, 900 milliamps, 1 amp, 1.1 amps, 2 amp, 2.1 amps, 3 amps, etc.) Any or all of the previously described embodiments may incorporate protective circuitry 775.

In some embodiments, the wearable apparatus may transmit data to a computing device (e.g., a smartphone, tablet, watch, computer, etc.) over one or more networks via any known wireless standard (e.g., cellular, Wi-Fi, Bluetooth®, etc.), or via near-filed capacitive coupling, other short range wireless techniques, or via a wired connection. Similarly, the wearable apparatus may receive data from the computing device over one or more networks via any known wireless standard (e.g., cellular, Wi-Fi, Bluetooth®, etc.), or via near-filed capacitive coupling, other short range wireless techniques, or via a wired connection. The data transmitted to the wearable apparatus and/or received by the wireless apparatus may include images, portions of images, identifiers related to information appearing in analyzed images or associated with analyzed audio, or any other data representing image and/or audio data. For example, an image may be analyzed and an identifier related to an activity occurring in the image may be transmitted to the computing device (e.g., the “paired device”). In the embodiments described herein, the wearable apparatus may process images and/or audio locally (on board the wearable apparatus) and/or remotely (via a computing device). Further, in the embodiments described herein, the wearable apparatus may transmit data related to the analysis of images and/or audio to a computing device for further analysis, display, and/or transmission to another device (e.g., a paired device). Further, a paired device may execute one or more applications (apps) to process, display, and/or analyze data (e.g., identifiers, text, images, audio, etc.) received from the wearable apparatus.

Some of the disclosed embodiments may involve systems, devices, methods, and software products for determining at least one keyword. For example, at least one keyword may be determined based on data collected by apparatus 110. At least one search query may be determined based on the at least one keyword. The at least one search query may be transmitted to a search engine.

In some embodiments, at least one keyword may be determined based on at least one or more images captured by image sensor 220. In some cases, the at least one keyword may be selected from a keywords pool stored in memory. In some cases, optical character recognition (OCR) may be performed on at least one image captured by image sensor 220, and the at least one keyword may be determined based on the OCR result. In some cases, at least one image captured by image sensor 220 may be analyzed to recognize: a person, an object, a location, a scene, and so forth. Further, the at least one keyword may be determined based on the recognized person, object, location, scene, etc. For example, the at least one keyword may comprise: a person's name, an object's name, a place's name, a date, a sport team's name, a movie's name, a book's name, and so forth.

In some embodiments, at least one keyword may be determined based on the user's behavior. The user's behavior may be determined based on an analysis of the one or more images captured by image sensor 220. In some embodiments, at least one keyword may be determined based on activities of a user and/or other person. The one or more images captured by image sensor 220 may be analyzed to identify the activities of the user and/or the other person who appears in one or more images captured by image sensor 220. In some embodiments, at least one keyword may be determined based on at least one or more audio segments captured by apparatus 110. In some embodiments, at least one keyword may be determined based on at least GPS information associated with the user. In some embodiments, at least one keyword may be determined based on at least the current time and/or date.

In some embodiments, at least one search query may be determined based on at least one keyword. In some cases, the at least one search query may comprise the at least one keyword. In some cases, the at least one search query may comprise the at least one keyword and additional keywords provided by the user. In some cases, the at least one search query may comprise the at least one keyword and one or more images, such as images captured by image sensor 220. In some cases, the at least one search query may comprise the at least one keyword and one or more audio segments, such as audio segments captured by apparatus 110.

In some embodiments, the at least one search query may be transmitted to a search engine. In some embodiments, search results provided by the search engine in response to the at least one search query may be provided to the user. In some embodiments, the at least one search query may be used to access a database.

For example, in one embodiment, the keywords may include a name of a type of food, such as quinoa, or a brand name of a food product; and the search will output information related to desirable quantities of consumption, facts about the nutritional profile, and so forth. In another example, in one embodiment, the keywords may include a name of a restaurant, and the search will output information related to the restaurant, such as a menu, opening hours, reviews, and so forth. The name of the restaurant may be obtained using OCR on an image of signage, using GPS information, and so forth. In another example, in one embodiment, the keywords may include a name of a person, and the search will provide information from a social network profile of the person. The name of the person may be obtained using OCR on an image of a name tag attached to the person's shirt, using face recognition algorithms, and so forth. In another example, in one embodiment, the keywords may include a name of a book, and the search will output information related to the book, such as reviews, sales statistics, information regarding the author of the book, and so forth. In another example, in one embodiment, the keywords may include a name of a movie, and the search will output information related to the movie, such as reviews, box office statistics, information regarding the cast of the movie, show times, and so forth. In another example, in one embodiment, the keywords may include a name of a sport team, and the search will output information related to the sport team, such as statistics, latest results, future schedule, information regarding the players of the sport team, and so forth. For example, the name of the sports team may be obtained using audio recognition algorithms.

### Generating Instructions to Find an Object

In some embodiments, the wearable apparatus described above may be used to locate objects within a field of view of a user. For example, a user of the device may request instructions to “find my keys” or ask “where's my phone?”. Based on these or similar commands, the device may provide feedback to the user, for example, through audio commands, to help the user locate the object. Such feedback may be useful in a variety of situations. For example, the system may be useful to visually impaired users, who are unable to see the object clearly for themselves. The disclosed device may be equally useful to users without an impairment as well. For example, the camera of the wearable device may be an infrared camera, or other type of camera that may detect different wavelengths of light than the user's eyes. Accordingly, in low-light situations or other conditions, the camera may be more apt to detect the object than the user. As another example, when the object is placed in a cluttered environment, the device may be able to locate the object quicker than the user. Further, in some instances, the user may not know what the object looks like but may know the name of the object. For example, if the user is working on a vehicle, he or she may wish to locate the engine speed sensor, but may not know where it is or what it looks like. Accordingly, the system may help the user find the sensor when working on the vehicle. Thus, the disclosed embodiments may provide, among other advantages, improved efficiency, convenience, and functionality over prior art devices.

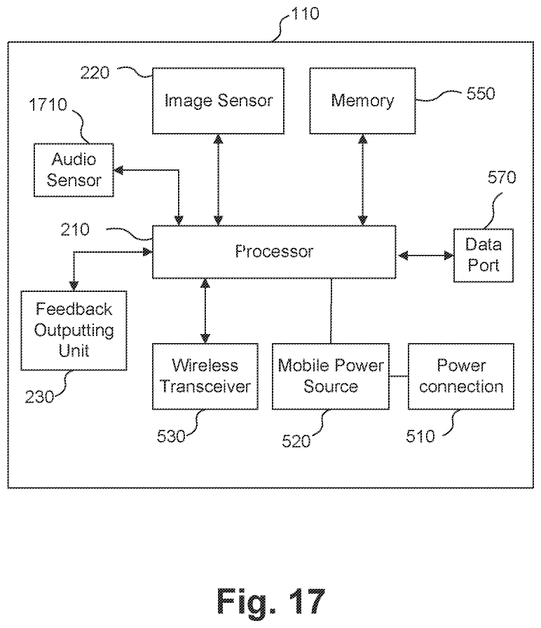

In some embodiments, apparatus 110 may be configured to receive and process audio information. For example, apparatus 110 may detect and capture sounds in the environment of the user via one or more microphones. Apparatus 110 may use this audio information to recognize words spoken by the user, which may include commands to find certain objects. FIG. 17 is a block diagram illustrating components of wearable apparatus 110, consistent with the disclosed embodiments. The wearable apparatus shown in FIG. 17 may include one or more of the features shown in FIG. 5A. For example, as discussed in greater detail above, wearable apparatus 110 may include a processor 210, image sensor 220, memory 550, wireless transceiver 530 and various other components as shown in FIG. 17. Wearable apparatus may further comprise an audio sensor 1710. Audio sensor 1710 may be any device capable of capturing sounds from an environment of a user and converting them to one or more audio signals. For example, audio sensor 1710 may comprise a microphone or another sensor (e.g., a pressure sensor, which may encode pressure differences comprising sound) configured to encode sound waves as a digital signal. As shown in FIG. 17, processor 210 may be configured to receive signals from audio sensor 1710 in addition to signals from image sensor 220. Further, while the system shown in FIG. 5A is used by way of example, audio sensor 1710 may be included in various other configurations of wearable apparatus 110. For example, the configurations shown in FIGS. 5B and 5C may similarly include audio sensor 1710 in communication with processor 210.

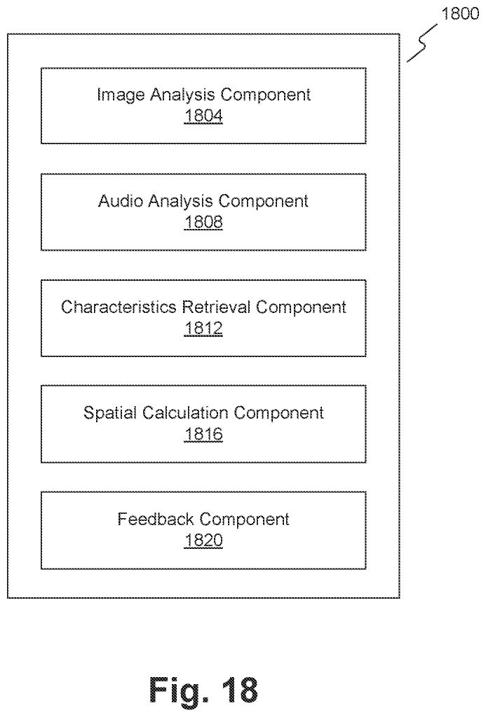

Processor 210 may be configured to perform a series of operations in accordance with the disclosed methods based on instructions stored in memory. FIG. 18 is a block diagram illustrating an example embodiment of a memory 1800 containing various components consistent with the present disclosure. Memory 1800 may be included in wearable apparatus 110 (e.g., as memory 550), may be included in another device in communication with wearable apparatus 110 (e.g., in computing device 120), or may be a stand-alone device. As shown in FIG. 18, memory 1800 may include various analysis components, such as image analysis component 1804 and/or audio analysis component 1808. Memory 1800 may further include additional components, such as characteristics retrieval component 1812, spatial calculation component 1816 and feedback component 1820. Each component 1804, 1808, 1812, 1816, and 1820 may contain software instructions for performing all or a portion of a method for providing directions for locating or reaching for objects. The instructions may be executed by a processing device, such as processor 210 and/or processor 540, included in wearable apparatus 110 or computing device 120, respectively. While components 1804, 1808, 1812, 1816, and 1820 are described separately, it is to be understood that any of these components may be combined with each other, or may be divided into two or more subcomponents.

Image analysis component 1804 may store instructions and data for performing tasks associated with analyzing images captured by wearable apparatus 110. For example, image analysis component 1804 may include one or more image detection algorithms and associated parameters for recognizing objects in images. For example, this may include image detection or processing algorithms such as convolutional neural networks (CNN), scale-invariant feature transform (SIFT), histogram of oriented gradients (HOG) features, or other techniques. Image analysis component 1804 may include instructions for detecting objects queried by a user, a hand of the user, and/or other objects that may be relevant to locating an object for a user.

Audio analysis component 1808 may store instructions and data for performing tasks associated with analyzing audio signals captured by wearable apparatus 110 or associated devices. For example, audio sensor 1710 may capture one or more audio signals from the environment of the user and processor 210 may analyze them using instructions stored in audio analysis component 1808. In some embodiments, audio analysis component 1808 may include one or more audio processing algorithms and associated parameters. For example, audio analysis may include speech recognition algorithms, such as automatic speech recognition (ASR) algorithms, Hidden Markov models, Dynamic time warping (DTW)-based speech recognition, natural language processing, or similar algorithms. In some embodiments, audio analysis component 1808 may be configured to recognize particular users, for example, by identifying voiceprints or other vocal signatures of a user.

Characteristics retrieval component 1812 may include instructions for retrieving visual characteristics of objects. For example, characteristics retrieval component 1812 may include instructions for accessing a database of visual characteristics associated with objects and comparing object descriptor words to the database to retrieve the visual characteristics. The database may be stored in any suitable storage location, including memory 550, a separate memory in wearable apparatus 100, a memory of an external device, a cloud-based storage platform, a remote server, or the like. As used herein, a visual characteristic may include any property of an object that may be observed or searched for in an image. For example, a visual characteristic may include a size, shape, color, texture, reflectivity, luminosity, or similar characteristics. In some embodiments, each of the characteristics may be stored with an associated probability. For example, if the queried object is an eraser, there may be a relatively high probability that the color is pink or white, and lower probabilities for other possible colors. In some embodiments, the visual characteristics may include one or more images of the object. These may include generic or stock images of objects, previous images captured by the wearable apparatus, user-captured images (e.g., through computing device 120), or various other types of images. Additional details regarding the retrieval of visual characteristics are provided below.

Spatial calculation component 1816 may include instructions for determining spatial relationships between objects detected in the environment of the user by the wearable apparatus. For example, this may include determining a distance and/or direction to an object relative to another object, such as the hand of a user. Accordingly, spatial calculation component 1816 may include one or more algorithms for determining three-dimensional positions of objects, including edge detection, corner detection, blob detection, ridge detection, and/or scale space algorithms. The direction may be determined along one axis at a time, such that usually up to three different sequences of commands may need to be provided to the user. In some embodiments, more than three different sequences of commands may be needed, for example, if the full required motion in one axis cannot be completed because an object is blocking it such that a movement may need to occur in a second dimension before a movement in the first dimension may be completed.

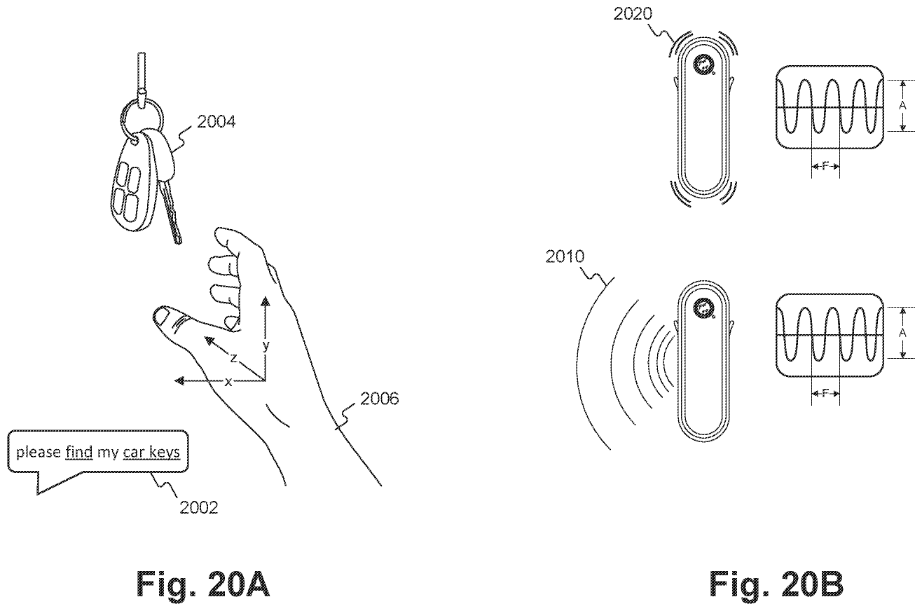

Feedback component 1820 may be configured to determine and provide feedback to a user. For example, the feedback may include instructions for the user to move his or her hand to reach a queried object. Feedback may be provided in a variety of ways. In some embodiments the feedback may be audio feedback. For example, the feedback may be instructions to move a hand in a specified direction and optionally in a specified distance (e.g., “up,” “forward 6 inches,” “left 20 centimeters,” or the like). The direction in which the hand is to be moved may be provided one axis at a time. For example, if the output is to be provided as audio, the words “up,” “right” or the like may be played. Alternatively, word combinations may be played, for example “right-up,” or the like. The audio feedback may also indicate the calculated distance, such that a greater sense of urgency is provided when the hand is closer to the object, for example higher volume, higher pitch, more frequent sounds, or the like. In some embodiments, haptic feedback may be provided. For example, wearable apparatus 110 may be configured to vibrate to indicate the distance and/or direction to an object. For example, a predetermined frequency may be used for each direction, where the distance may be expressed by the motion amplitude, such that more intense vibrations are provided as the distance to the object is reduced. As another example, the device may vibrate in a predetermined sequence of directions (e.g., left/right-up/down-forward/back) and the frequency may indicate which direction to move (e.g., up vs. down), where the amplitude indicates the distance. Various other schemes may be used for providing haptic feedback to represent a distance and direction, as described further below with respect to FIG. 20B.

In some embodiments, feedback component 1820 may include instructions for providing the feedback to an output unit. For example, feedback component 1820 may provide the feedback for output to a speaker of wearable apparatus 110, a speaker of computing device 120, or any other audio device in communication with wearable apparatus 110. Alternatively, feedback component 1820 may provide the feedback for output to a vibration motor of wearable apparatus 110, a vibration motor of computing device 120, or any other vibration device in communication with wearable apparatus 110. The feedback may be transmitted directly for output or stored in a memory for later output, or a combination thereof. As another example, the feedback may be transmitted directly to an outputting unit, such as feedback outputting unit 230 or 545. The feedback may be output by any means disclosed herein. While described as a single component for simplicity, it is to be understood that the feedback component may include separate feedback determination and feedback output components.

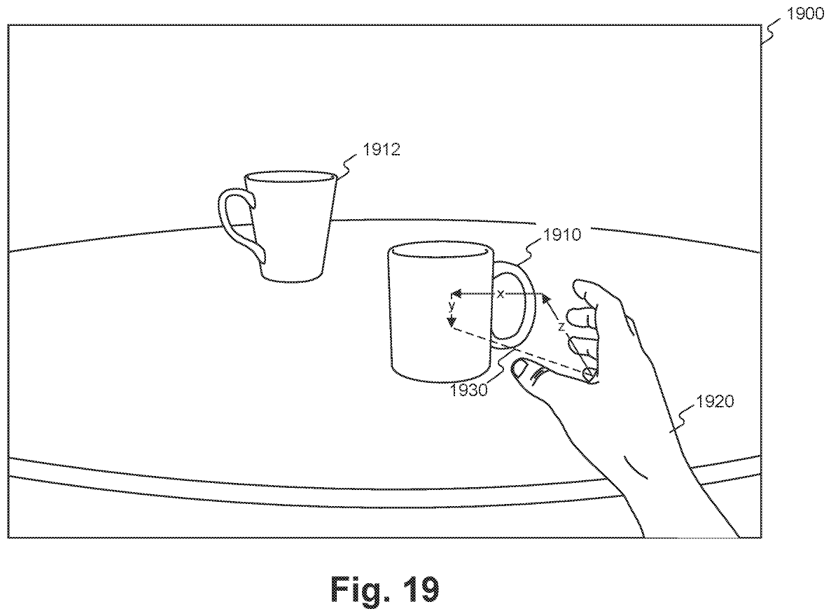

FIG. 19 is an illustration of an example image 1900 that may be used for locating an object, consistent with the disclosed embodiments. Image 1900 may be captured using an image sensor, such as image sensor 220 of wearable apparatus 110. Accordingly, image 1900 may include representations of objects within the environment of a user of wearable apparatus 110. For example, image 1900 may include representations of coffee cups 1910 and 1912 that a user may be able to interact with. Image 1900 may further include representation(s) of a hand 1920 of the user. Wearable apparatus 110 may be configured to identify these objects using image analysis component 1804 through various object and feature detection techniques, as described above.

Wearable apparatus 110 may be configured to process audio signals in connection with processing image 1900. For example, a user may issue a command to find coffee cup 1910. The command may be presented in various ways. In some embodiments, wearable apparatus 110 may search for and identify descriptor words within audio signals captured by audio sensor 1710. These descriptor words may be compared to a database to identify visual characteristics associated with the object. In the example shown in image 1900, the descriptor word may be “coffee cup.” In some embodiments, wearable apparatus 110 may use one or more natural language processing algorithms to identify the descriptor word. For example, the user may use various other words to describe coffee cup 1910, such as “mug,” “my coffee,” “the cup,” “cappuccino,” “hot chocolate” or other similar words. Wearable apparatus 110 may associate these words with the term “coffee cup” prior to searching the database, which may reduce the number of descriptor words that must be stored. Alternatively or additionally, the database may associate multiple descriptor words with each object.

Based on the identified descriptor word, wearable apparatus 110 may search a database for objects that match the identified descriptor word to identify visual characteristics of the coffee cup. For example, these visual characteristics may include data defining a shape, size, color, or texture of the coffee cup, words or images expected to be found on the coffee cup, or other visual characteristics. In some embodiments, the visual characteristics may include an image of a coffee cup. For example, this may include a generic image of a coffee cup (e.g., a stock photo, a pre-stored system photo, etc.). In some embodiments, wearable apparatus 110 may be configured to search the internet, a separate image database, or other sources to retrieve a generic image of a coffee cup, which may then be stored for future analysis. In some embodiments, the image may be an image previously captured by wearable apparatus 110 or another device, such as computing device 120. For example, wearable apparatus 110 may capture an image of coffee cup 1930 and may store it for future analysis. In some embodiments, a user may be able to associate the image with the descriptor word. For example, the user may point image sensor 220 at coffee cup 1910 and say “this is the coffee cup” which may prompt wearable apparatus to store the image for future use. As another example, the user may capture an image of coffee cup 1910 using computing device 120 and may enter text or voice recordings identifying the object as the coffee cup.

In some embodiments, detection of one or more objects may occur prior to identifying the descriptor word. For example, wearable apparatus 110 may detect representations of objects in the captured image and may compare these representations to the visual characteristic database. Accordingly, the system may automatically associate descriptors with objects in the environment. Then, when the user queries an object using the descriptor word, the object may already have been identified in the images.

According to some embodiments, the user may provide an input triggering detection of the descriptor word. For example, the user may say “find the coffee cup,” “please find my glasses,” or “where are my keys.” The system may recognize “find,” “please find,” or “where are” as instruction words triggering detection of the descriptor word. The system may use word spotting or other speech recognition tools to detect the instruction words. In some embodiments, the descriptor word may be identified based on its proximity within the audio signal to the instruction word. For example, the system may look for a descriptor word following (or in some cases, preceding) the instruction word. In some embodiments, the instruction word may be a predefined command or set of commands known by the user. Alternatively or additionally, the system may be configured to recognize commands from the user's natural speech. For example, the instruction word may be determined through natural language processing algorithms, similar to the descriptor word described above. Various other means for triggering detection of the descriptor word may be used. For example, the user may press a button or select an option through a graphical user interface (e.g., on computing device 120) indicating the user will provide the descriptor word.

In some embodiments, the descriptor word may be associated with a modifier, which may be used to identify the correct object in the database. For example, rather than finding a coffee cup in general, the user may specify a particular coffee cup. As other examples, the user may say “find my coffee,” “locate Dave's phone,” “where's the blue marker,” or “help me pick up the convertible keys,” where “my,” “Dave's,” “blue,” and “the convertible” are modifiers specifying a particular object or distinguishing the object from other similar objects. In the example shown in FIG. 19, when the user speaks the words “my coffee,” this may specifically refer to coffee cup 1910 as opposed to coffee cup 1912. Accordingly, the database may include a separate entry for the user's coffee cup with distinct visual characteristics of the particular object. Similarly, “the convertible keys” may be distinguishable from other keys, such as “the truck keys” or “Kate's keys.” The database may store separate visual characteristics for each of these particular objects and, in some embodiments, a set of visual characteristics for a generic object, such as “keys.” In some embodiments the modifier word may override various visual characteristics in the database. For example, if a user says “find the blue eraser,” and the database associates “eraser” with a white or pink object, the system may override the color property of the stored visual characteristics to locate the blue eraser.

As described above, the user may provide input defining the particular object. For example, the user may say “this is my phone,” which may associate an image of the user's phone with the user in the database. The system may then store the image in the database for future analysis. Accordingly, the system may recognize “this is,” “save this as,” or similar commands as instruction words for storing visual characteristics. In some embodiments, the system may extract other visual characteristics, such as shape, size, and color, and store this information in the database associated with the particular object.

Based on visual characteristics retrieved using characteristics retrieval component 1812, wearable apparatus 110 may determine a location of coffee cup 1910 and a hand 1920 of the user. This may include comparing the stored visual characteristics to image data, as described above. In some embodiments, the system may be configured to distinguish between multiple possible objects. In the example shown in FIG. 19, the system may distinguish between coffee cup 1910 and coffee cup 1912. In some embodiments, this may be based on a relative distance from the objects to the user. For example, although image 1910 contains two coffee cups, the system may select coffee cup 1910 as the object to find because it is closest to the user. Various other rules may be used to distinguish between multiple objects matching the visual characteristics. For example, the system may further be configured to determine a confidence level (e.g., a score, a percentage, a probability, etc.) indicating a degree to which the located object matches the visual characteristics and may select the object with the highest confidence level.

Wearable apparatus 110 may then determine distance and/or direction information between the user's hand and the located object. For example, spatial calculation component 1816 may be used to determine direction 1930 (which may also include a distance) between hand 1920 and coffee cup 1910. This distance and direction information may be conveyed to the user to help locate the object, as described further below with respect to FIGS. 20A and 20B. The distance and direction information may be determined relative to a reference point of the located object. For example, the reference point may be a centroid of the representation of the object in the image, a point in the object closest to the user's hand, or the like. In some embodiments the reference point may be determined based on properties of the object. For example, if the user is reaching for a knife, the reference point may be on the handle of the knife, rather than on the blade. This reference point may be determined based on analysis of the image (e.g., detecting a handle). According to some embodiments, information regarding the reference point may be stored in the database. For example, a reference image may include a preferred reference point location that is aligned with representations of the object in the image when locating the object.

In some embodiments, the distance and direction may be broken into multiple components. For example, direction 1930 may be broken into x, y, and z components, as shown in FIG. 19. These components may be based on various forms of coordinate systems that may be used by the system. For example, the coordinate system may be defined relative to image 1910, wearable apparatus 110, a user of wearable apparatus 110, hand 1920, or various other coordinate systems.

FIGS. 20A and 20B illustrate various forms of feedback that may be provided to a user, consistent with the disclosed embodiments. As shown in FIG. 20B, a user may be looking for an object, such as keys 2004. A user may assert a voice command 2002 including the phrase “please find my car keys.” As described above, wearable apparatus 110 may recognize the word “find” as an instruction word and “car keys” as a descriptor word and may locate keys 2004 based on voice command 2002. Wearable apparatus 110 may then determine a distance and/or direction from hand 2006 of the user to keys 2004. The distance and/or direction may be based on a reference coordinate system, which may be based on a hand of the user, as shown in FIG. 20A.

Wearable apparatus 110 may then be configured to provide feedback to the user through feedback component 1820. FIG. 20B illustrates example feedback that may be provided. In some embodiments, this may be presented as auditory feedback. For example, wearable apparatus 110 or a separate device (e.g., a hearing aid device, computing device 120, etc.) may present audio feedback to the user for locating the object. For example, wearable apparatus 110 may present audio feedback 2010 based on the distance and/or direction from hand 2006 to keys 2004. In some embodiments, audio feedback 2010 may include a voice command or prompt. For example, the voice prompt may tell the user to “move forward 6 inches and up 2 inches.” As another example, the command may be a series of direction words, such as “left” and “forward” that are repeated until the user reaches the object. This may also include a combination of directions such as “left-up” or similar prompts. Audio signal 2010 may use other properties, such as volume, spacing between prompts, or other properties to convey information. For example, the system may repeat the word “left” until the hand is aligned with the object on the x-axis and may increase or decrease the volume, increase or decrease the spacing at which the word is repeated, or vary other properties as the user approaches the alignment. In some embodiments, the command may be based only on x and y directions (e.g., left/right and up/down) and the user may then move forward until he or she reaches the object.

As another example, audio feedback 2010 may include a tone, a beep, or a series of tones or beeps. For example, as shown in FIG. 20B, wearable apparatus 110 may vary an amplitude (A) of the signal and/or frequency (F) of the signal to convey information to the user. A greater volume or higher frequency may be associated with a shorter distance, or vice versa. This may also apply to the prompt words described above. In some embodiments, the system may vary an amplitude (e.g., volume), frequency (e.g. tone or pitch), timing (e.g., spacing between beeps or tones), or a combination of these properties as the user moves his or her hand. For example, audio feedback 2010 may comprise a series of beeps and the spacing between the beeps may decrease as the user approaches the object. In some embodiments, these properties may vary for a particular axis. For example, the timing between the beeps may decrease as the user aligns his or her hand with the object along an x-y plane and the volume may increase as the user approaches the object in the z direction. While these forms of feedback are provided by way of example, one skilled in the art would recognize other properties or combinations of properties that may be used to convey the object location.

In some embodiments, wearable apparatus 110 or a separate device (e.g., a hearing aid device, computing device 120, etc.) may present haptic feedback to the user for locating the object. For example, wearable apparatus 110 may present haptic feedback 2020 based on the distance and/or direction from hand 2006 to keys 2004. This may include vibrational feedback, electrical stimulation feedback, ultrasonic feedback, or any other form of tactile feedback. Similar to audio feedback 2010, wearable apparatus 110 may vary one or more properties of the feedback, such as a frequency (F), an amplitude (A), timing between signals, or other variables to convey the distance and/or direction information. For example, the amplitude may indicate a distance to the object, whereas a frequency may indicate a direction to the object (e.g., varying frequency as the user moves his or her hand along an x-y plane, etc.). Various other properties or combinations of properties may be used to convey the information to the user.

In some embodiments, the feedback may be presented to the user in other ways. For example, the feedback may be presented to the user on a display of wearable apparatus 110, computing device 120, or a separate device. This may be useful in embodiments where the user needs help recognizing a particular object, where the user needs help identifying the object in a crowded space with many objects, where the user is farsighted and can see the screen despite not being able to see the object, or various other scenarios. The feedback may be presented in other forms, such as a light or series of lights, or any other means of providing information to the user.

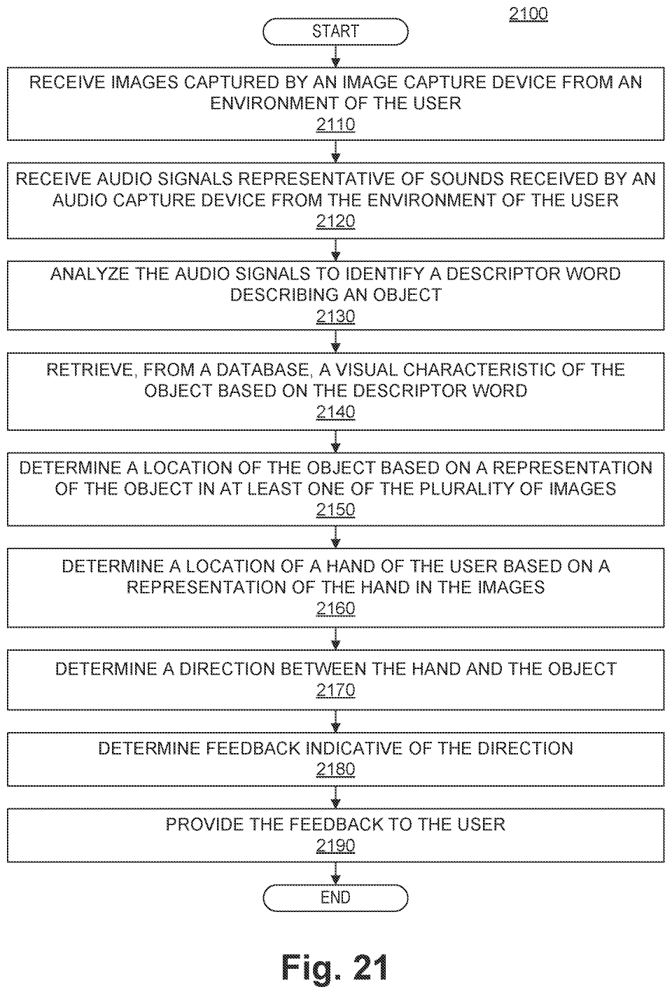

FIG. 21 is a flowchart showing an example process 2100 for locating an object for a user, consistent with the disclosed embodiments. Process 2100 may be performed by at least one processing device of a wearable apparatus, such as processor 210, as described above. In some embodiments, some or all of process 2100 may be performed by a different device, such as computing device 120. It is to be understood that throughout the present disclosure, the term “processor” is used as a shorthand for “at least one processor.” In other words, a processor may include one or more structures that perform logic operations whether such structures are collocated, connected, or disbursed. In some embodiments, a non-transitory computer readable medium may contain instructions that when executed by a processor cause the processor to perform process 2100. Further, process 2100 is not necessarily limited to the steps shown in FIG. 21, and any steps or processes of the various embodiments described throughout the present disclosure may also be included in process 2100, including those described above with respect to FIGS. 18-20B.

In step 2110, process 2100 may include receiving a plurality of images captured by an image capture device from an environment of the user. For example, this may include receiving image 1900 captured by image sensor 220. As described above, one or more of the images may include representations of objects within the environment of the user.

In step 2120, process 2100 may include receiving audio signals representative of sounds received by an audio capture device from the environment of the user. For example, audio sensor 1710 may capture sounds from the environment of the user and may transmit them to processor 210. This may include voice commands spoken by the user, as described above.

In step 2130, process 2100 may include analyzing the audio signals to identify a descriptor word describing the object. The descriptor word may include any spoken word or group of words describing an object in the environment of the user. In some embodiments, the descriptor word may include a modifier that may further define the object or may identify a particular object, as described in greater detail above. In some embodiments, the descriptor word may be identified based on an instruction word or other input by a user. For example, step 2130 may further include analyzing the audio signal to identify an instruction word, as described above. The instruction word may be any word or group of words indicating the user is looking for an object. For example, the instruction word may be a pre-defined command for locating an object. This may be a default command for wearable apparatus 110, a user-defined command, or the like. In some embodiments, the descriptor word may be identified based on a proximity of the descriptor word to the instruction word. For example, the system may detect the instruction word and may search for the descriptor word as a word following (or preceding) the instruction word. For example, step 2130 may include using a word spotting technique on the audio signals to detect instruction words and the descriptor word may be identified based on detection of the instruction word.

In some embodiments, analyzing the audio signals may comprise identifying an audio signal associated with a voice of the user. For example, this may include detecting voices from the audio signals and isolating them from background noise or other audio signals. In some embodiments, this may include detecting the voice of a particular user. For example, step 2120 may include determining a voiceprint associated with the audio signal and comparing the voiceprint to a stored voiceprint of the user to determine whether the user is speaking. Various other forms of analysis may be performed on the audio signals.

In step 2140, process 2100 may include retrieving, from a database, a visual characteristic of the object based on the descriptor word. The database may be stored locally on wearable apparatus 110 (e.g., in memory 550), in computing device 120, on a remote server, on a cloud-bases platform, or the like. The visual characteristics may include various information associated with the appearance of the object. For example, this may include a size, shape, color, texture, luminosity, reflectivity, or other visual properties of an object. In some embodiments, the visual properties may be represented as an image or series of images. Accordingly, retrieving the visual characteristic may comprise retrieving an image of the object, as described above.

In step 2150, process 2100 may include determining a location of the object based on a representation of the object in at least one of the plurality of images. In some embodiments, the representation of the object may be identified based on the visual characteristic. For example, if the visual characteristic is represented by an image, step 2150 may include comparing the retrieved image to the captured image to detect the representation of the object in the captured image. In some embodiments, step 2150 may include distinguishing between multiple objects represented in the image that may match the descriptor word. This may include determining a confidence level associated with each object in the image and locating the object with the highest associated confidence level. In some embodiments, the objects may be distinguished based on other factors, such as a relative distance to the user, or other factors. In some embodiments, the most recent image or set of images may be used to determine the location of the object. In some embodiments, the object may be detected in earlier images. For example, if the object is not found in the most recent image or images, step 2150 may include searching previous images until the object is found. Accordingly, the previous images may be stored locally on wearable apparatus 110 (e.g., in memory 550, a temporary memory (e.g., RAM)), etc.) or on a separate device (e.g., computing device 120, a remote storage database, a cloud-storage platform, etc.). In some embodiments, a user may provide an input indicating a time or timeframe that the object may be found in the images. For example, the user may say “I put my keys down when I got home at 2 PM,” which may prompt the system to search images with timestamps near 2:00 PM. In some embodiments, a default or user-defined time setpoint may indicate how earlier the system should begin searching.

In step 2160, process 2100 may include determining a location of a hand of the user based on a representation of the hand in at least one of the plurality of images. For example, step 2160 may determine a location of hand 1920 in image 1900. This may include applying one or more feature or object recognition algorithms to locate the hand, as described above.

In step 2170, process 2100 may include determining a direction between the hand and the object. For example, step 2170 may include determining direction 2130 between hand 1920 and coffee cup 1910. In some embodiments, this direction may be represented as a vector in a coordinate system. For example, the direction may be broken into x, y, and z components, as shown in FIG. 19. In some embodiments, step 2170 may include determining a distance between the hand and the object, which may be performed in addition to or as an alternative to determining the direction. In step 2180, process 2100 may include determining feedback indicative of the direction. This may include determining on or more feedback parameters to convey the direction and/or distance identified in step 2170. Accordingly, the feedback may comprise one or more instructions for the user to move the hand towards the object. Additionally, the instructions may be updated and/or supplemented as the user moves his or her hand.

In step 2190, process 2100 may include providing the feedback to the user. This may include generating a signal based on the determined feedback and transmitting the signal to a feedback device, such as a motor, a speaker, a display, a light, etc. In some embodiments, providing the feedback may comprise presenting audio feedback to the user, as described above. For example, the audio feedback may comprise words describing the direction, and at least one of a volume or a pitch of the audio feedback may indicate a distance between the hand and the object. A higher volume or higher pitch of the audio feedback may indicate a shorter distance, or vice versa. In some embodiments, providing the feedback may comprise providing haptic feedback to the user. For example, the haptic feedback may comprise a vibration and a frequency of the vibration may be indicative of the direction. Similarly, an amplitude of the vibration may be indicative of a distance between the hand and the object. Various other properties or combinations of properties of the haptic or audio feedback may be varied to convey the distance and/or direction information.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A wearable apparatus for locating an object for a user, the wearable apparatus comprising:
at least one image capture device configured to capture a plurality of images from an environment of the user of the wearable apparatus;
at least one audio capture device configured to receive sounds from the environment of the user; and
at least one processor configured to:
receive the plurality of images captured by the image capture device;
receive audio signals representative of the sounds received by the audio capture device;
analyze the audio signals to identify a descriptor word describing the object;
retrieve, from a database, a visual characteristic of the object based on the descriptor word;
determine a location of the object based on a representation of the object in at least one of the plurality of images, the representation of the object being identified based on the visual characteristic;
determine a location of a hand of the user based on a representation of the hand in at least one of the plurality of images;
determine at least a direction between the hand and the object;
determine feedback indicative of the direction; and
provide the feedback to the user.

2. The wearable apparatus of claim 1, wherein retrieving the visual characteristic comprises retrieving an image of the object.

3. The wearable apparatus of claim 1, wherein analyzing the audio signals comprises identifying an audio signal associated with a voice of the user.

4. The wearable apparatus of claim 1, wherein the processor is further configured to analyze the audio signal to identify an instruction word and wherein the descriptor word is identified based on a proximity of the descriptor word to the instruction word.

5. The wearable apparatus of claim 4, wherein the instruction word comprises a user-defined command.

6. The wearable apparatus of claim 1, wherein the feedback comprises instructions for the user to move the hand towards the object.

7. The wearable apparatus of claim 1, wherein providing the feedback comprises presenting audio feedback to the user.

8. The wearable apparatus of claim 7, wherein the audio feedback comprises words describing the direction, and at least one of a volume or a pitch of the audio feedback indicates a distance between the hand and the object.

9. The wearable apparatus of claim 8, wherein a higher volume of the audio feedback indicates a shorter distance.

10. The wearable apparatus of claim 8, wherein a higher pitch of the audio feedback indicates a shorter distance.

11. The wearable apparatus of claim 1, wherein providing the feedback comprises providing haptic feedback to the user.

12. The wearable apparatus of claim 11, wherein the haptic feedback comprises a vibration and a frequency of the vibration is indicative of the direction.

13. The wearable apparatus of claim 11, wherein the haptic feedback comprises a vibration and an amplitude of the vibration is indicative of a distance between the hand and the object.

14. The wearable apparatus of claim 1, wherein the at least one processor is further configured to determine a distance between the hand and the object, and wherein the feedback is further indicative of the distance.

15. A method for locating an object for a user, the method comprising:
receiving a plurality of images captured by an image capture device from an environment of the user;
receiving audio signals representative of sounds received by an audio capture device from the environment of the user;
analyzing the audio signals to identify a descriptor word describing the object;
retrieving, from a database, a visual characteristic of the object based on the descriptor word;
determining a location of the object based on a representation of the object in at least one of the plurality of images, the representation of the object being identified based on the visual characteristic;
determining a location of a hand of the user based on a representation of the hand in at least one of the plurality of images;
determining at least a direction between the hand and the object;
determining feedback indicative of the direction; and
providing the feedback to the user.

16. The method of claim 15, wherein retrieving the visual characteristic comprises retrieving an image of the object.

17. The method of claim 15, wherein analyzing the audio signals comprises identifying an audio signal associated with a voice of the user.

18. The method of claim 15, wherein the method further comprises analyzing the audio signal to identify an instruction word and wherein the descriptor word is identified based on a proximity of the descriptor word to the instruction word.

19. The method of claim 18, wherein identifying the instruction word comprises identifying a user-defined command.

20. The method of claim 15, wherein providing the feedback comprises providing instructions for the user to move the hand towards the object.

21. The method of claim 15, wherein providing the feedback comprises presenting audio feedback to the user.

22. The method of claim 21, wherein the audio feedback comprises words describing the direction, and at least one of a volume or a pitch of the audio feedback indicates a distance between the hand and the object.

23. The method of claim 22, wherein a higher volume of the audio feedback indicates a shorter distance.

24. The method of claim 22, wherein a higher pitch of the audio feedback indicates a shorter distance.

25. The method of claim 15, wherein providing the feedback comprises providing haptic feedback to the user.

26. The method of claim 25, wherein the haptic feedback comprises a vibration and a frequency of the vibration is indicative of the direction.

27. The method of claim 25, wherein the haptic feedback comprises a vibration and an amplitude of the vibration is indicative of a distance between the hand and the object.

28. The method of claim 15, wherein the method further comprises determining a distance between the hand and the object, and wherein the feedback is further indicative of the distance.

29. A non-transitory computer readable medium including instructions that, when executed by at least one processor, cause the at least one processor to perform operations for locating an object for a user, the operations comprising:
receiving a plurality of images captured by an image capture device from an environment of the user;
receiving audio signals representative of sounds received by an audio capture device from the environment of the user;
analyzing the audio signals to identify a descriptor word describing the object;
retrieving, from a database, a visual characteristic of the object based on the descriptor word;
determining a location of the object based on a representation of the object in at least one of the plurality of images, the representation of the object being identified based on the visual characteristic;
determining a location of a hand of the user based on a representation of the hand in at least one of the plurality of images;
determining at least a direction between the hand and the object;
determining feedback indicative of the direction; and
provide the feedback to the user.
